(19) United States
(12) Patent Application Publication
(10) Pub. No.: US 2013/0238689 A1
(43) Pub. Date: Sep. 12, 2013

(54) SERVER APPARATUS AND IMAGE DISPLAY SYSTEM

(71) Applicants: Hiroyuki MATSUSHIMA, Kanagawa (JP); Daigo Uchiyama, Kanagawa (JP); Kohta Nagai, Kanagawa (JP)

(72) Inventors: Hiroyuki MATSUSHIMA, Kanagawa (JP); Daigo Uchiyama, Kanagawa (JP); Kohta Nagai, Kanagawa (JP)

(73) Assignee: RICOH COMPANY, LTD., Tokyo (JP)

(21) Appl. No.: 13/774,046

(22) Filed: Feb. 22, 2013

(30) Foreign Application Priority Data
Mar. 6, 2012 (JP) 2012-049067

(51) Int. Cl. H04L 29/06

(52) U.S. Cl. CPC H04L 67/42
USPC 709/203

(57) ABSTRACT

A server apparatus capable of connecting to a content providing apparatus which provides content and an image display apparatus via a network, includes an index data processing unit which provides index data to the image display apparatus, based on content to be provided by the content providing apparatus, for having the image display apparatus display a list screen including information of the content; and an image data processing unit which provides image data to the image display apparatus for having the image display apparatus display a content display screen using information of the content selected from the list screen by an operator.

### BACKGROUND OF THE INVENTION

1. Field of the Invention

The present invention relates to a server apparatus and an image display system.

2. Description of the Related Art

Recently, it has become general practice for workers in an office to have a conference or the like at which a personal computer (PC) is connected to a projector and an image is projected by the projector. Further, a projector capable of projecting images by reading projectable files from an attached USB memory is also known (see Patent Document 1, for example).

However, in the conventional projector, it is necessary to connect a PC or attach a USB memory which stores images in order to project the images.

Thus, it is necessary to bring the PC or the USB memory which stores the images when bringing a projector for projecting the images.

### PATENT DOCUMENT

[Patent Document 1] Japanese Laid-open Patent Publication No. 2008-310247

### SUMMARY OF THE INVENTION

The present invention is made in light of the above problems, and provides an image display technique capable of improving convenience of an image display apparatus.

According to an embodiment, there is provided a server apparatus capable of connecting to a content providing apparatus which provides content and an image display apparatus via a network, including an index data processing unit which provides index data to the image display apparatus, based on content to be provided by the content providing apparatus, for having the image display apparatus display a list screen including information of the content; and an image data processing unit which provides image data to the image display apparatus for having the image display apparatus display a content display screen using information of the content selected from the list screen by an operator.

According to another embodiment, there is provided an image display system, including a server apparatus which provides content; and an image display apparatus which displays the content and is connected to the server apparatus via a network. The server apparatus includes an index data processing unit which provides index data to the image display apparatus, based on content to be provided by a content providing apparatus, for having the image display apparatus display a list screen including information of the content; and an image data processing unit which provides image data to the image display apparatus for having the image display apparatus display a content display screen using information of the content selected from the list screen by an operator. The image display apparatus includes a list screen display unit which displays the list screen including the information of the content based on the provided index data, and a content display screen display unit which displays the content display screen based on the provided image data.

Note that also arbitrary combinations of the above-described constituents, and any exchanges of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a block diagram showing an example of a structure of a projection system;

FIG. 2 is a block diagram showing an example of a hardware structure of a projection server;

FIG. 3 is a block diagram showing an example of a software structure of the projection server;

FIG. 4 is a schematic view showing an example of a process between the projection server and a projector;

FIG. 5 is a view showing an example of URLs received by a dispatcher unit;

FIG. 6 is a flowchart showing an example of an operation of a dispatcher unit;

FIG. 7 is a view showing an example of a dispatch table;

FIG. 8 is flowchart showing an example of an operation of a root controller;

FIG. 9 is a view showing an example of user information;

FIG. 10 is a view showing an example of a data structure of a root index file;

FIG. 11 is a view showing an example of a file list screen;

FIG. 12 is a flowchart showing an example of an operation of an external service controller;

FIG. 13 is a sequence diagram showing an example of an operation of providing an index file in step S32 of FIG. 12;

FIG. 14 is a sequence diagram showing an example of an operation of providing the index file in step S32 of FIG. 12;

FIG. 15 is a sequence diagram showing an example of an operation of providing a content file in step S33 of FIG. 12;

FIG. 16 is a sequence diagram showing another example of providing the content file in step S33 of FIG. 12;

FIG. 17 is a sequence diagram showing another example of an operation of providing the content file in step S33 of FIG. 12;

FIG. 18 is a flowchart showing an example of an operation of an external service controller;

FIG. 19 is a flowchart showing another example of an operation of the external service controller;

FIG. 20 is a flowchart showing another example of an operation of the external service controller;

FIG. 21 is a flowchart showing another example of an operation of the external service controller;

FIG. 22 is a view showing an example of file information;

FIG. 23 is a flowchart showing another example of an operation of the external service controller;

FIG. 24 is a flowchart showing an example of an operation of uploading a file;

FIG. 25 is a view showing another example of the file information;

FIG. 26 is a flowchart showing an example of an operation of sending a file;

FIG. 27 is a flowchart showing an operation of setting an end of the validated date of the file information;

FIG. 28 is a flowchart showing an operation of deleting a file for which the validated date is expired;

FIG. 29 is a view showing an example of a screen which accepts an instruction to delete a file by an operator;

FIG. 30 is a sequence diagram showing an operation of setting performed by cooperation between the projection server and the external service;

FIG. 31 is a sequence diagram showing an operation of projecting performed by the cooperation between the projection server and the external service;

FIG. 32A and FIG. 32B are views showing an example of a portal screen displayed after an operator logs in;

FIG. 33 is a view showing a correspondence between user information and authentication data of the external service;

FIG. 34 is a sequence diagram showing an operation of setting by cooperation of the projection server and the external service;

FIG. 35 is a sequence diagram showing an operation of projection performed by cooperation of the projection server and the external service;

FIG. 36 is a view showing a correspondence between the user information and the authentication data of the external service;

FIG. 37 is a block diagram showing an example of a multifunction machine which cooperates with the projection server;

FIG. 38 is a block diagram showing an example of a digital camera and a fixed camera which cooperate with the projection server;

FIG. 39 is a block diagram showing an example of a PC which cooperates with the projection server; and

FIG. 40 is a block diagram showing an example of a storage server which cooperates with the projection server.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### First Embodiment

### (System Structure)

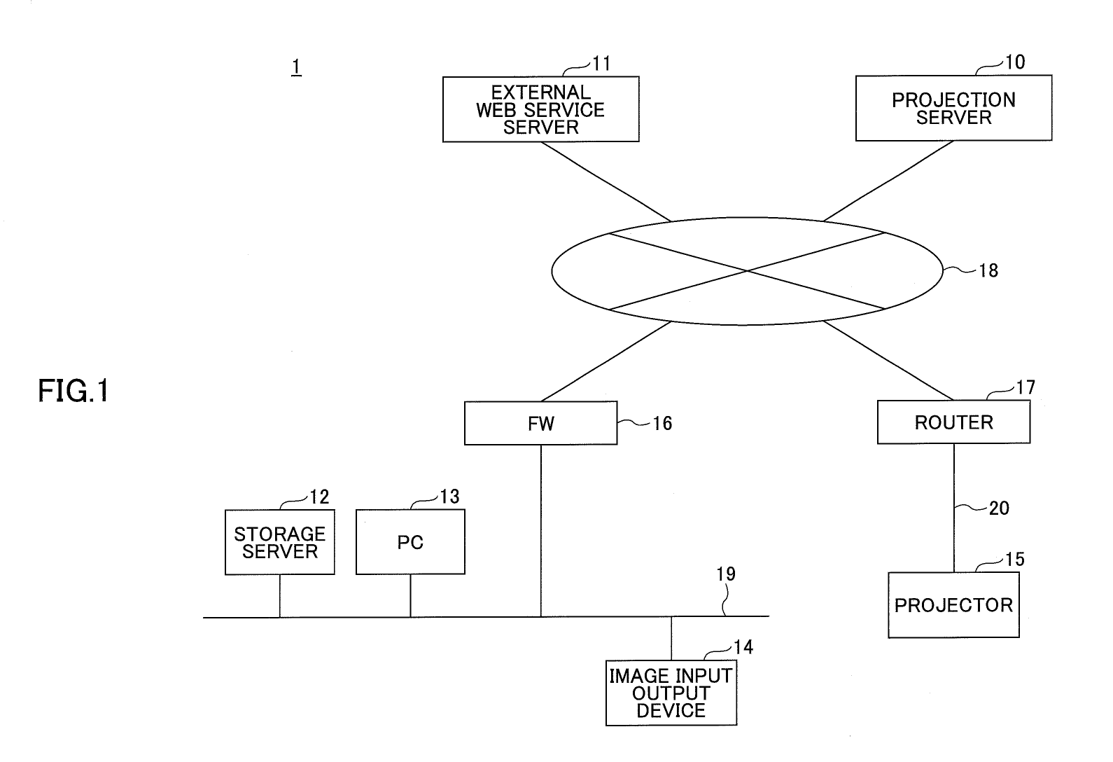

FIG. 1 is a block diagram showing an example of a projection system 1. The projection system 1 includes a projection server 10, an external Web service server 11, a storage server 12, a PC 13, an image input output device 14, a projector 15, a fire wall (FW) 16, a router 17, and networks 18 to 20.

The projection server 10 and the external Web service server 11 are connected with each other via the network 18 such as the INTERNET. For example, the projection server 10 and the external Web service server 11 are provided on a cloud. The external Web service server 11 provides a Web service (to the projection server 10. The external Web service server 11 is an example of a content providing apparatus which provides content to the projection server 10 using the Web service. The external Web service server 11 provides a Web service such as a storage service, an application service or the like on the cloud.

The network 19 such as LAN is connected to the network 18 via the FW 16. The storage server 12, the PC 13 and the image input output device 14 are connected to the network 19.

Each of the storage server 12, the PC 13 and the image input output device 14 provides a Web service to the projection server 10. The storage server 12, the PC 13 and the image input output device 14 are also an example of the content providing apparatus which provides content to the projection server 10 using the Web service.

The storage server 12, the PC 13 and the image input output device 14 are an example of the content providing apparatus which provides content to the projection server 10 by uploading, which will be explained later. The image input output device 14 is, for example, an image processing apparatus such as a multifunction machine, a scanner, a digital camera or the like which includes an image input device capable of generating image data.

The network 20 such as LAN is connected to the network 18 via the router 17. The projector 15 is connected to the network 20. The projector 15 has a client function which cooperates with the projection server 10. The projector 15 obtains content from the projection server 10 using the client function and projects the obtained content, as will be explained later. The networks 19 and 20 may employ wire or wireless communication, and may include both.

The projection server 10 is an example of a server apparatus. The projector 15 of the embodiment is an example of an image display apparatus. The projection system 1 is an example of an image display system. The projection by the projector 15 is an example of a display by the image display apparatus. Further, the external Web service server 11, the storage server 12, the PC 13 and the image input output device 14 are examples of the content providing apparatus which provides content to the image display apparatus.

### (Hardware Structure)

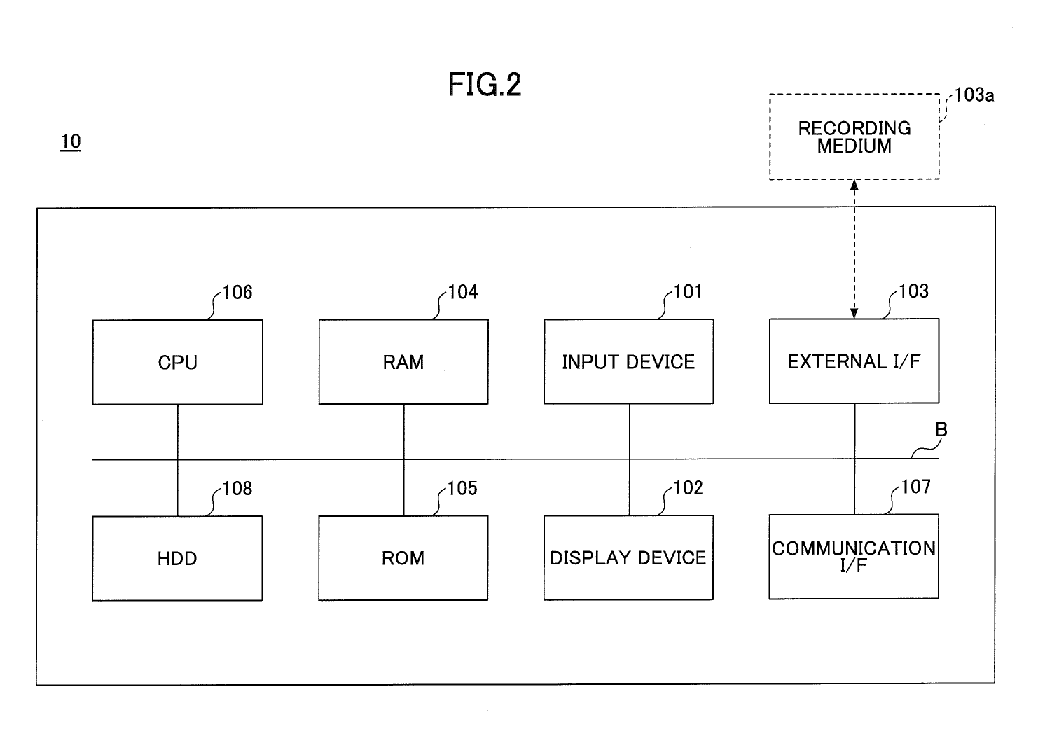

FIG. 2 is a block diagram showing an example of a hardware structure of the projection server 10. The projection server 10 includes an input device 101, a display device 102, an external I/F 103, a RAM 104, a ROM 105, a CPU 106, a communication I/F 107, a HDD 108 and the like which are connected to each other via a bus B.

The input device 101 includes a keyboard, a mouse or the like and is used for inputting various operation signals to the projection server 10. The display device 102 includes a display or the like and displays management data of the projection server 10 or logs.

The communication I/F 107 is an interface for connecting the projection server 10 to the network 18. The projection server 10 is capable of having data communication with the external Web service server 11, the storage server 12, the PC 13, the image input output device 14 and the projector 15 via the communication I/F 107.

The HDD 108 is a non-volatile storing unit which stores programs or data. The programs or data stored in the HDD 108 includes an OS, which is basic software for controlling the entirety of the projection server 10, application software which provides various functions on the OS, or the like. The HDD 108 manages the programs or data which are stored therein by a predetermined file system and/or a database (DB).

The external I/F 103 is an interface for an external device. The external device may be a recording medium 103a or the like. The projection server 10 is capable of reading and/or writing data between the recording medium 103a via the external I/F 103. The recording medium 103a may be a flexible disk, a CD, a DVD, a SD memory card, a USB memory or the like.

The ROM 105 is a non-volatile semiconductor memory (storing unit) which is capable of storing programs or data even when the power supply is off. The ROM 105 stores programs or data such as BIOS which is executed when the projection server 10 is initiated, an OS setting, a network setting or the like. The RAM 104 is a volatile semiconductor memory (storing unit) which temporarily stores programs or data.

The CPU 106 is an arithmetic unit which actualizes the control or function of the entirety of the projection server 10 by reading programs or data from a storing unit such as the ROM 105, the HDD 108 or the like into the RAM 104 and executing processes.

The projection server 10 is capable of actualizing the various functions, which will be explained later, by the above explained hardware structure. Alternatively, instead of the hardware structure, a virtual machine on an Infrastructure as a Service (IaaS), which has been developed recently, may be used.

### (Software Structure)

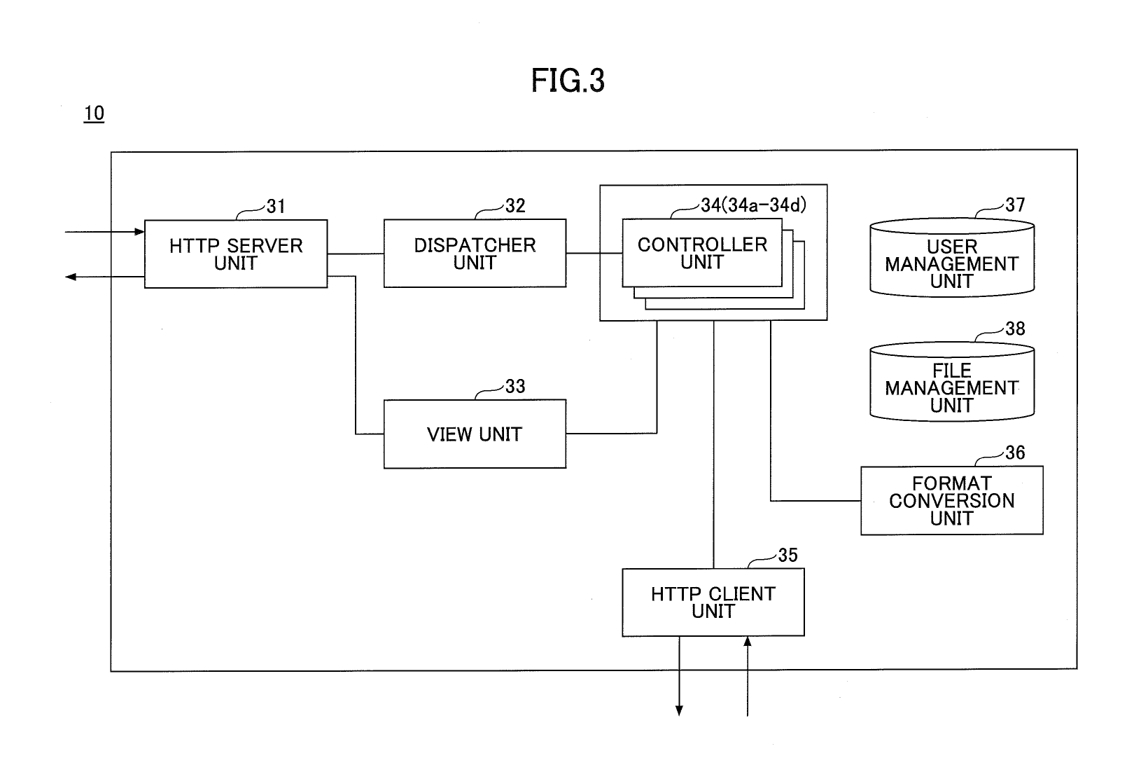

FIG. 3 is a block diagram showing an example of a software structure of the projection server 10.

The projection server 10 can function as an HTTP server unit 31, a dispatcher unit 32, a view unit 33, one or more controller unit(s) 34, an HTTP client unit 35, a format conversion unit 36, a user management unit 37, and a file management unit 38 by executing a program.

The HTTP server unit 31 performs HTTP (S) communication with the projector 15 or a browser (not shown in the drawings). The browser is embodied in a PC operated by an operator, a PC which uploads content to the projection server 10, which will be explained later, or the like, for example. The HTTP client unit 35 performs HTTP(S) communications with the external Web service server 11, the storage server 12, the PC 13 and the image input output device 14.

In the following, a phrase “external service” is used for a Web service in which the external Web service server 11 provides content (an example of first content) to the projection server 10 and a Web service in which the storage server 12, the PC 13 or the image input output device 14 provides content (an example of first content) to the projection server 10.

The user management unit 37 stores and manages user information, authentication data of the external service or the like. Although not shown in the drawings, the projection server 10 includes a storing unit (internal storage) which is composed of the HDD 108 shown in FIG. 2, for example, and provides an internal storage service in which the content (an example of second content) previously obtained from the external Web service server 11, the storage server 12, the PC 13 or the image input output device 14 is stored in the storing unit and managed.

The file management unit 38 stores and manages file information of an uploaded file, a converted file as will be explained later, a temporary file which is downloaded from the external Web service server 11, the storage server 12, the PC 13 or the image input output device 14, or the like, stored in the storing unit by the internal storage service of the projection server 10. The file stored and managed by the file management unit 38 includes an index file, which will be explained later, and a content file.

The index file is an example of index data. The index file includes data related to content files which are capable of being provided to the projector 15, and includes list data of the content files. Specifically, the index file includes data of the content file and the subdirectory capable of being provided to the projector 15, as will be explained later. The content file is an example of image data. The content file may be a static image, a motion picture file, or the like.

The HTTP server unit 31 receives an HTTP request from the projector 15 or an HTTP client unit (not shown in the drawings) of the browser (not shown in the drawings). The HTTP server unit 31 interprets the received HTTP request and sends necessary data (URL) to the dispatcher unit 32. The dispatcher unit 32 dispatches the received URL to the controller unit 34 as will be explained later.

In this embodiment, the controller unit 34 includes a root controller 34a, an internal storage service controller 34b and external service controllers 34c and 34d. The internal storage service controller and the external service controllers included in the controller unit 34 may be varied in accordance with internal storage services and external services to be used. For example, when there are two external services to be used, the controller unit 34 may include the external service controllers 34c and 34d for the external services to be used, respectively. Alternatively, the controller unit 34 may include the external service controller for each kind of the external services.

The controller unit 34 performs an operation of obtaining an index file, an operation of obtaining a content file or the like, as will be explained later, in accordance with the URL dispatched by the dispatcher unit 32. The controller unit 34 controls the format conversion unit 36 to convert the format of the index file or the content file to a format projectable by the projector 15 in accordance with necessity.

The controller unit 34 sends the index file and the content file to be sent to an HTTP client unit (not shown in the drawings) of the projector 15, to the HTTP server unit 31. The controller unit 34 stores the content file uploaded by the HTTP client unit (not shown in the drawings) of the browser (not shown in the drawings) in a storage (internal storage) of the projection server 10. The controller unit 34 sends data to be displayed by the HTTP client unit (not shown in the drawings) of the browser (not shown in the drawings) to the view unit 33. The view unit 33 generates an HTML file and sends the HTML file to the HTTP server unit 31. The HTTP server unit 31 sends the received index file, the content file and the HTML file as an HTTP response to the projector 15 or the HTTP client unit (not shown in the drawings) of the browser (not shown in the drawings).

### (Operation)

### (Operation of Projection Server 10 and Projector 15)

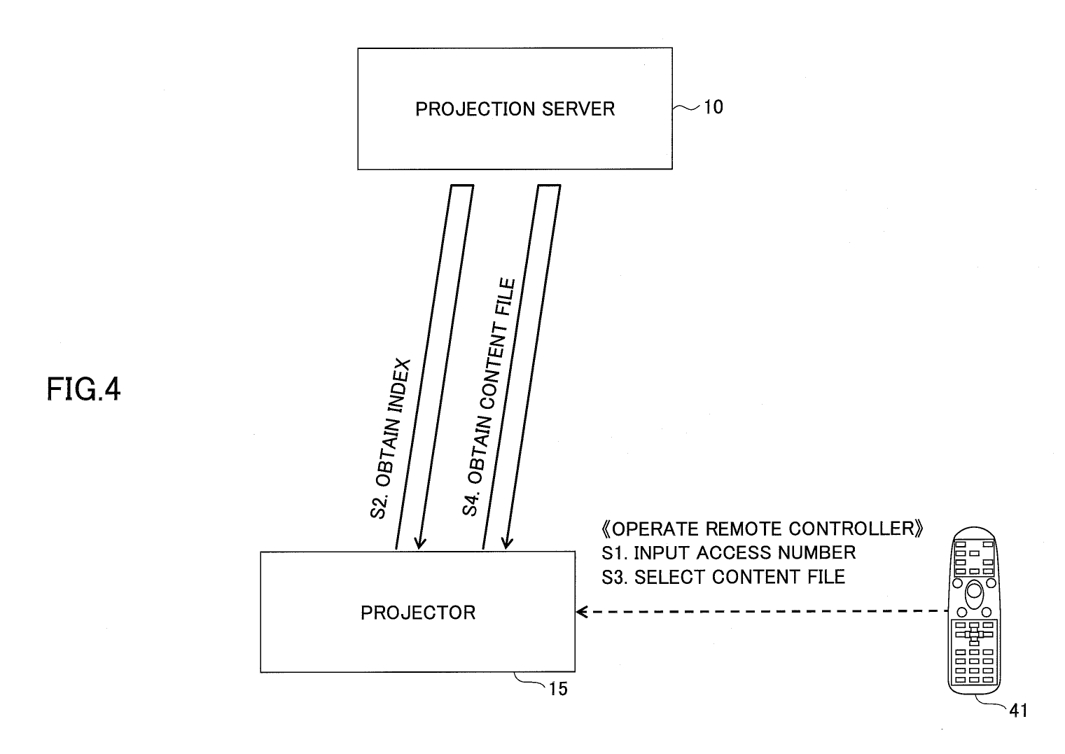

FIG. 4 is a schematic view showing an example of a process between the projection server 10 and the projector 15. Here, in this embodiment, an example in which an access limitation using an access number is set is explained, where the access limitation may be performed by using an IC card, a fingerprint authentication apparatus or the like.

In step S1, after instructing the projector 15 to start projection of a file list screen to, the operator of the projector 15 operates a remote controller 41 of the projector 15, for example, to input an access number.

In step S2, the projector 15 obtains an index file from the projection server 10. The index file obtained from the projection server 10 includes information of a content file which is in correspondence with the access number.

The projector 15 generates a file list screen from the index file obtained from the projection server 10. The file list screen is explained later in detail. In step S3, the operator of the projector 15 operates the remote controller 41 to select a content file to be projected from the file list screen.

In step S4, the projector 15 obtains the content file selected by the operator from the projection server 10. The projector 15 generates a content file screen from the obtained content file and projects the content file screen.

### (Operation of Dispatcher Unit 32)

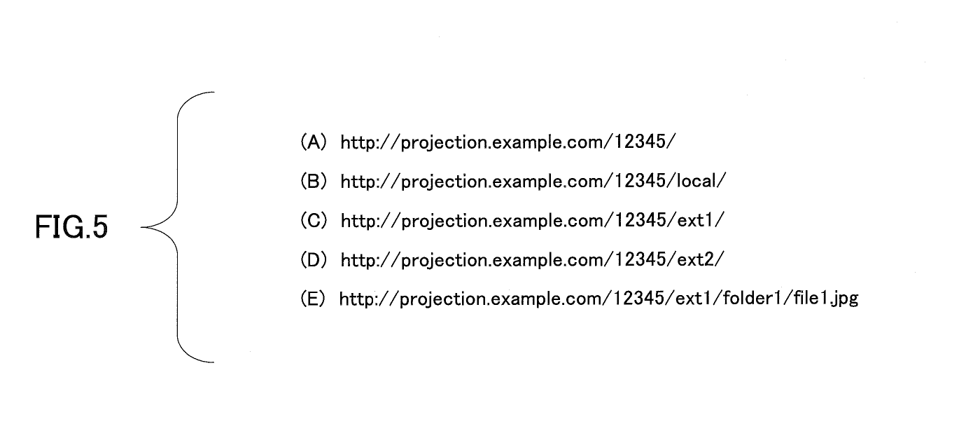

The dispatcher unit 32 receives URLs shown in FIG. 5 from the HTTP server unit 31, for example. FIG. 5 is a view showing an example of URLs received by the dispatcher unit 31. The dispatcher unit 32 obtains a URL as shown in (A) of FIG. 5 from the HTTP server unit 31, for example, after the operator of the projector 15 instructs the projector 15 to start operation (instructs to project the file list screen).

The dispatcher unit 32 obtains a URL as shown in (B) of FIG. 5 from the HTTP server unit 31, for example, after the operator of the projector 15 selects a subdirectory of an internal storage service from the file list screen.

The dispatcher unit 32 receives an URL as shown in (C) of FIG. 5 or (D) of FIG. 5 from the HTTP server unit 31, for example, after the operator of the projector 15 selects a subdirectory of an external service from the file list screen. Further, the dispatcher unit 32 receives an URL as shown in (E) of FIG. 5 from the HTTP server unit 31, for example, after the operator of the projector 15 selects a content file included in the subdirectory of the external service from the file list screen.

The URL shown in (A) of FIG. 5 includes a host URL “projection.example.com” and an access number “12345”. The URL shown in (B) of FIG. 5 has a structure in which data “local” indicating the internal storage service is added to the URL shown in (A) of FIG. 5. The URL shown in (C) of FIG. 5 has a structure in which data “ext1” indicating the external service is added to the URL shown in (A) of FIG. 5. The URL shown in (D) of FIG. 5 has a structure in which data “ext2” indicating the external service is added to the URL shown in (A) of FIG. 5.

The URL shown in (E) of FIG. 5 has a structure in which data “folder1” indicating the subdirectory and data “file1.jpg” indicating the content file are added to the URL shown in (C) of FIG. 5. The “folder1/file1.jpg” shown in (E) of FIG. 5 is an example of a URL path in the external service. The “12345/ext1/folder1/file1.jpg” shown in (E) of FIG. 5 is an example of a URL path in the projection server 10.

The dispatcher unit 32 determines the controller unit 34 to which the URL is dispatched based on the URL received from the HTTP server unit 31 as shown in (A) to (E) of FIG. 5. For example, the URL shown in (A) of FIG. 5 is dispatched to the root controller 34a. The URL shown in (B) of FIG. 5 is dispatched to the internal storage service controller 34b. The URL shown in (C) of FIG. 5 is dispatched to the external service controller 34c of the external service (ext1). The URL shown in (D) of FIG. 5 is dispatched to another external service controller 34d of the external service (ext2). The URL shown in (E) of FIG. 5 is dispatched to the external service controller 34c.

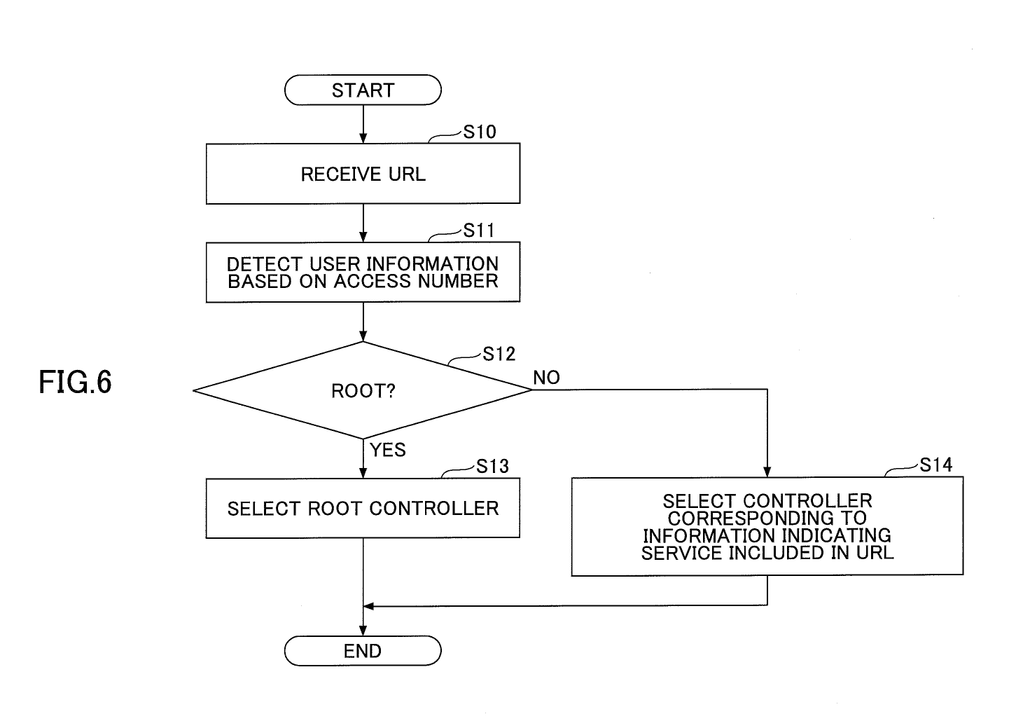

FIG. 6 is a flowchart showing an example of an operation of the dispatcher unit 32.

In step S10, the dispatcher unit 32 receives a URL from the HTTP server unit 31. In step S11, the dispatcher unit 32 detects user information of the operator stored in the user management unit 37 based on the access number {n} included in the received URL. In step S12, the dispatcher unit 32 determines whether the received URL indicates a root.

When the received URL is composed of a host URL and the access number, the dispatcher unit 32 may determine that the received URL indicates a root.

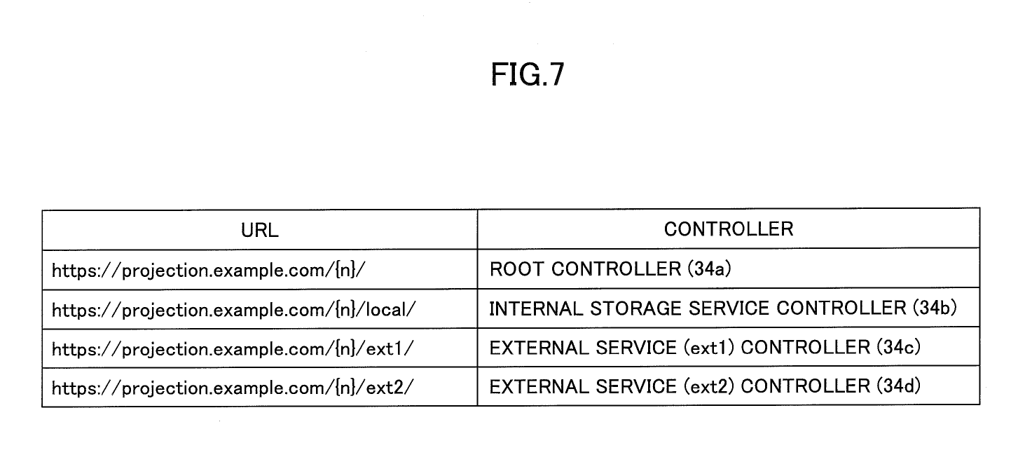

Alternatively, the dispatcher unit 32 may determine whether the received URL indicates a root by using a dispatch table in which URLs are in correspondence with one of the root controller 34a, the internal storage service controller 34b, the external service (ext1) controller 34c and the external service (ext2) controller 34d as shown in FIG. 7, for example. At this time, the URL which is in correspondence with the root controller 34a is determined to indicate a root.

FIG. 7 is a view showing an example of the dispatch table. The dispatch table shown in FIG. 7 shows an example in which three services including an internal storage service and two external services are registered in the projection server 10.

When the received URL indicates a root, the dispatcher unit 32 selects the root controller 34a and dispatches the URL in step S13. When the received URL does not indicate a root, the dispatcher unit 32 performs a process in step S14.

In step S14, the dispatcher unit 32 selects one of the internal storage service controller 34b, the external service (ext1) controller 34c and the external service (ext2) controller 34d based on information included in the received URL indicating the service (“local”, “ext1” or the like) and dispatches the URL. For example, the dispatcher unit 32 may select one of the internal storage service controller 34b, the external service (ext1) controller 34c and the external service (ext2) controller 34d which is in correspondence with the information indicating the service in the dispatch table shown in FIG. 7.

(Operation of Root Controller 34a)

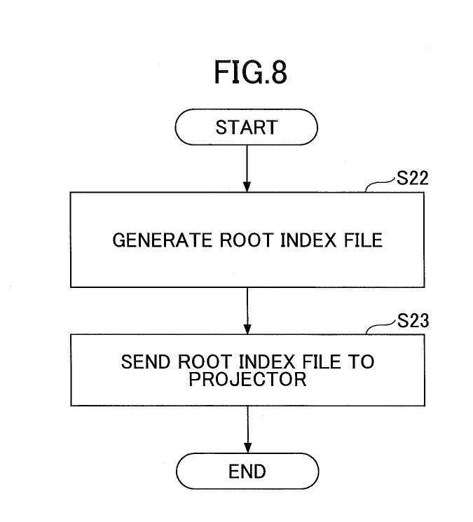

The root controller 34a performs an operation shown in FIG. 8. FIG. 8 is flowchart showing an example of an operation of the root controller 34a.

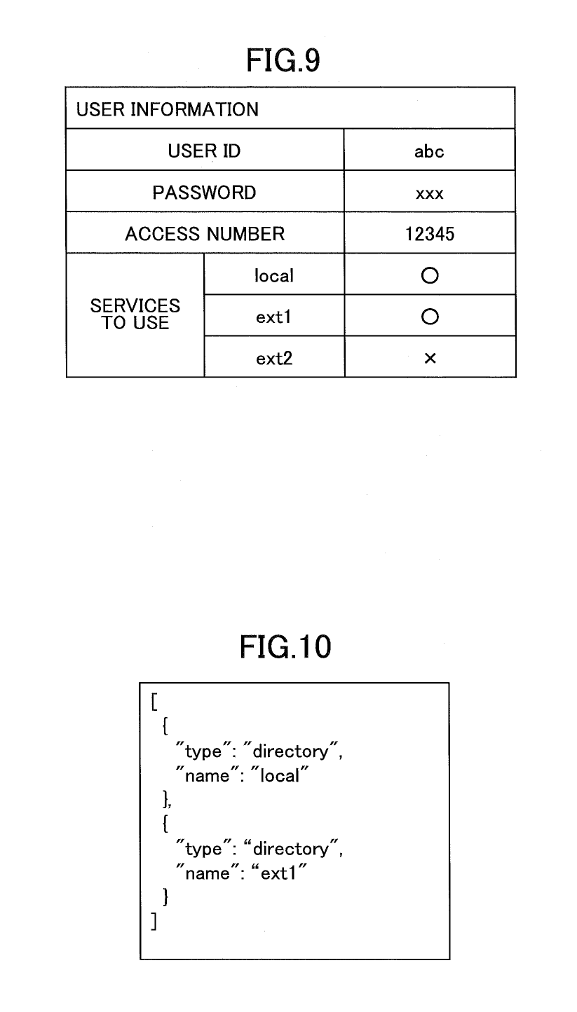

FIG. 9 is a view showing an example of the user information. The user information includes items such as user ID, a password, an access number, and services to use. For the services to use, the services, such as the internal storage service and/or the external service, for which the operator of the projector 15 is capable of using are registered. For an example shown in FIG. 9, the operator whose access number is “12345” is capable of using the internal storage service (local) and the external service (ext1).

Referring back to FIG. 8, in step S22, the root controller 34a generates a root index file in which the internal storage service or the external service capable of being used by the operator is listed as a directory list based on the services to be used included in the user information detected in step S11.

FIG. 10 is a view showing an example of a data structure of the root index file. The root index file shown in FIG. 10 includes a directory list of the internal storage service (local) and the external service (ext1) which the operator is capable of using.

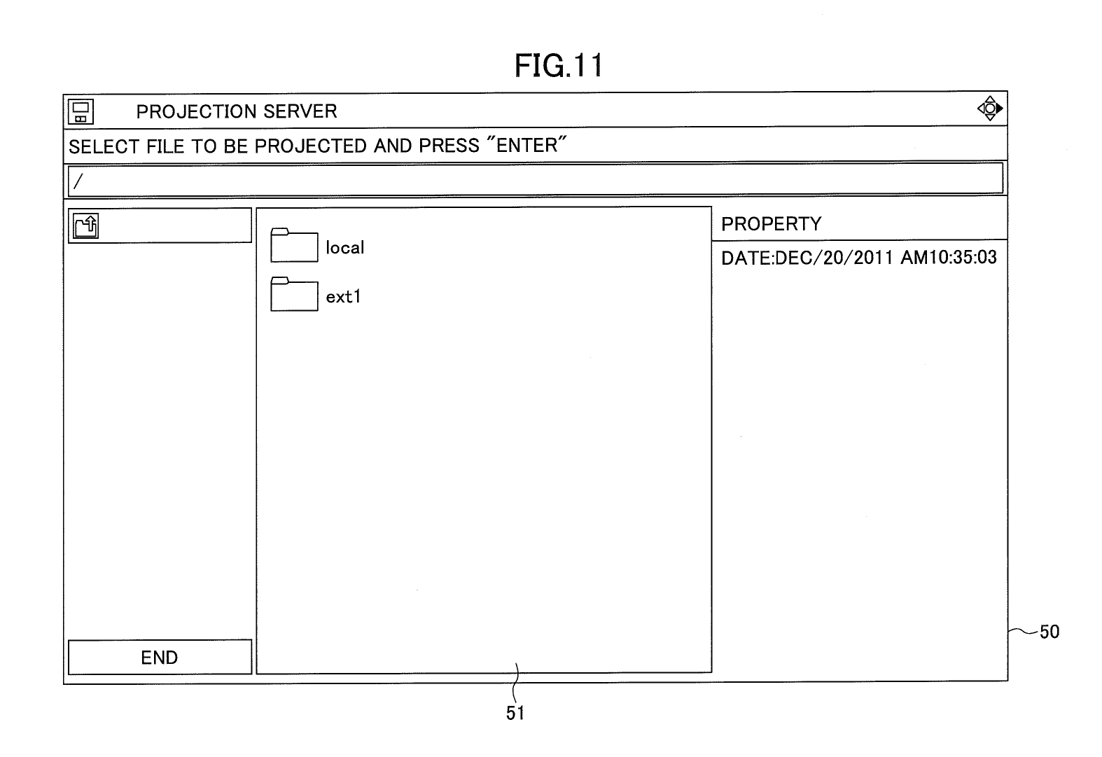

Referring back to FIG. 8, in step S23, the root controller 34a sends the root index file generated in step S22 to the projector 15 via the HTTP server unit 31. Upon receiving the root index file, the projector 15 displays a file list screen 50 as shown in FIG. 11, for example.

FIG. 11 is a view showing an example of the file list screen 50. The file list screen 50 includes a file list display area 51. Directory data included in the root index file is displayed in the file list display area 51. The directory data displayed in the file list display area 51 corresponds to the internal storage service (local) and the external service (ext1) for which the operator is capable of using.

(Operation of External Service Controller 34c (or 34d))

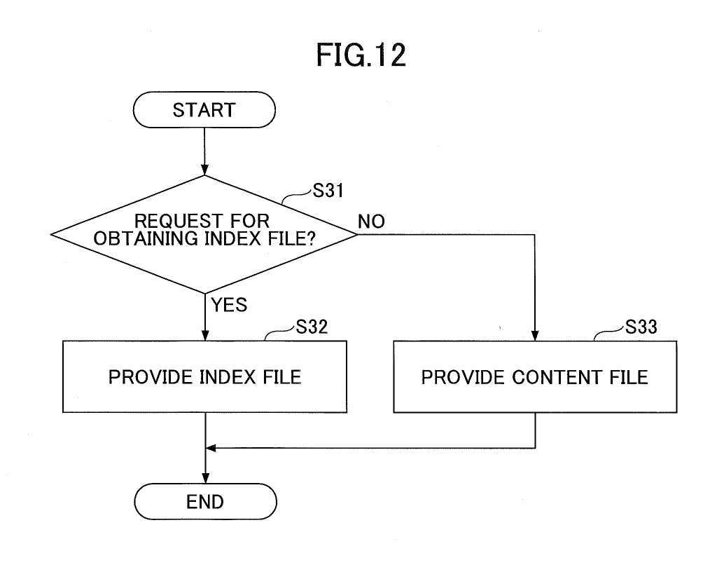

An operation of the external service controller varies in accordance with the external service. Thus, an example of the operation of the external service controller 34c is schematically explained. FIG. 12 is a flowchart showing an example of an operation of the external service controller 34c.

Upon receiving a URL from the dispatcher unit 32, the external service controller 34c determines whether it is the request for obtaining the index file based on the received URL in step S31. For example, the external service controller 34c determines that it is the request for obtaining the index file when the last symbol of the received URL is “/”.

When the URL is determined to be the request for obtaining the index file, the external service controller 34c performs an operation of providing an index file in step S32, which will be explained later. When the URL is not determined to be the request for obtaining the index file, the external service controller 34c performs an operation of providing a content file in step S33, which will be explained later.

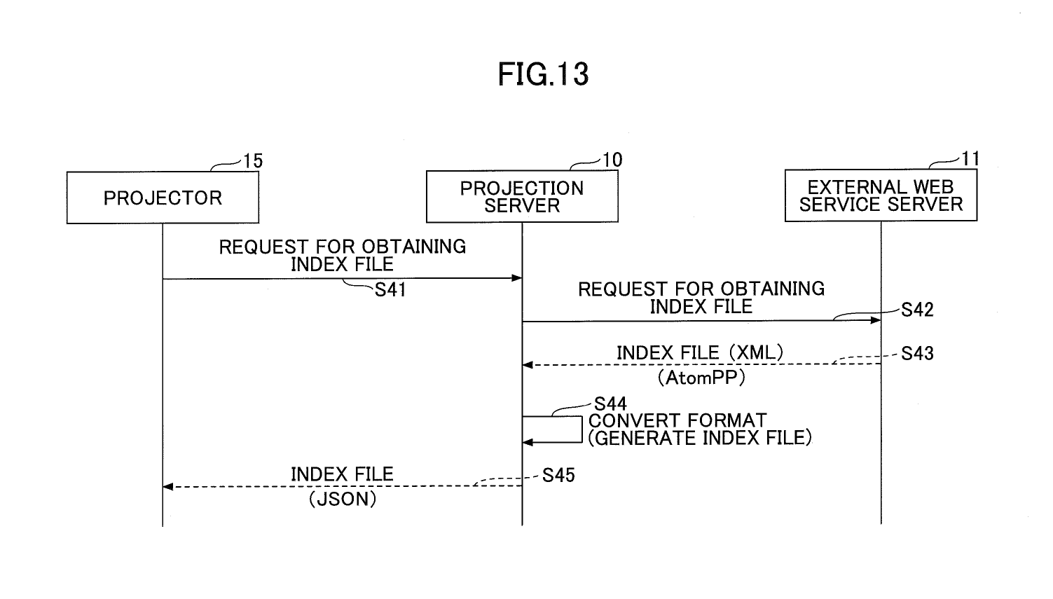

Here, the operation of providing the index file in step S32 is performed by the cooperation of the projector 15 and the external service. Thus, the operation of providing the index file in step S32 is explained with reference to a sequence diagram shown in FIG. 13. FIG. 13 is a sequence diagram showing an example of the operation of providing the index file in step S32. In FIG. 13, the external Web service server 11 is exemplified as an example of the content providing apparatus which provides the external service.

In step S41, the projection server 10 receives the request for obtaining the index file of the external Web service server 11 by receiving the URL as shown in (C) of FIG. 5, for example. In step S42, the projection server 10 sends the request for obtaining the index file to the external Web service server 11.

In step S43, the projection server 10 receives an index file which is described in an Extensible Markup Language (XML) format, for example, from the external Web service server 11.

In step S44, the projection server 10 converts the index file of the external Web service server 11 from the XML format to a JavaScript Object Notation (JSON) format. Here, when the index file received in step S43 is in the JSON format, the process of step S44 is omitted. In step S45, the projection server 10 provides the index file of the external Web service server 11 in the JSON format to the projector 15.

Further, there may be a case when a content file stored in the external Web service server 11 is in a multi-page format (for example, PDF format or the like), for which it is impossible for the projector 15 to project. For the operation of providing the index file in step S32 in FIG. 12, such a case is also considered. When the content file in the multi-page format is stored in the external Web service server 11, the projection server 10 includes the content file in the multi-page format as a subdirectory (hereinafter, referred to as a “subdirectory indicating the content file”) in the index file.

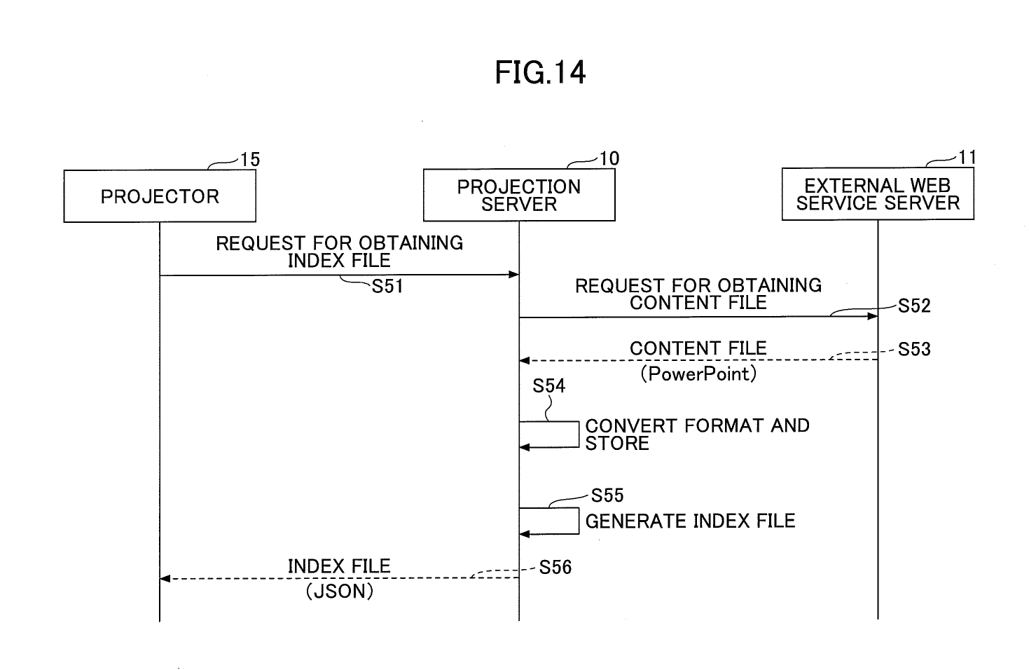

When the operator selects a subdirectory indicating the content file in the multi-page format from the file list screen in the projector 15, the operation of providing the index file in step S32 is performed as processes shown in a sequence diagram of FIG. 14.

FIG. 14 is a sequence diagram showing another example of an operation of providing a content file in step S32 of FIG. 12. In step S51, the projection server 10 receives a request for obtaining the index file of the subdirectory indicating the content file.

In step S52, the projection server 10 sends a request for obtaining the content file specified by the subdirectory indicating the content file to the external Web service server 11.

In step S53, the projection server 10 receives the content file in a multi-page format (for example, Power Point or the like) from the external Web service server 11. In step S54, the projection server 10 converts the content file in the multi-page format to content files in a single-page format (for example, JPEG format or the like) and stores the converted content files in the internal storage. It means that the content file in the multi-page format is converted to the content files of the numbers corresponding to the pages.

In step S55, the projection server 10 generates an index file of the content files stored in the internal storage in step S54 in the JSON format. Then, in step S56, the projection server 10 provides the index file generated in step S55 to the projector 15.

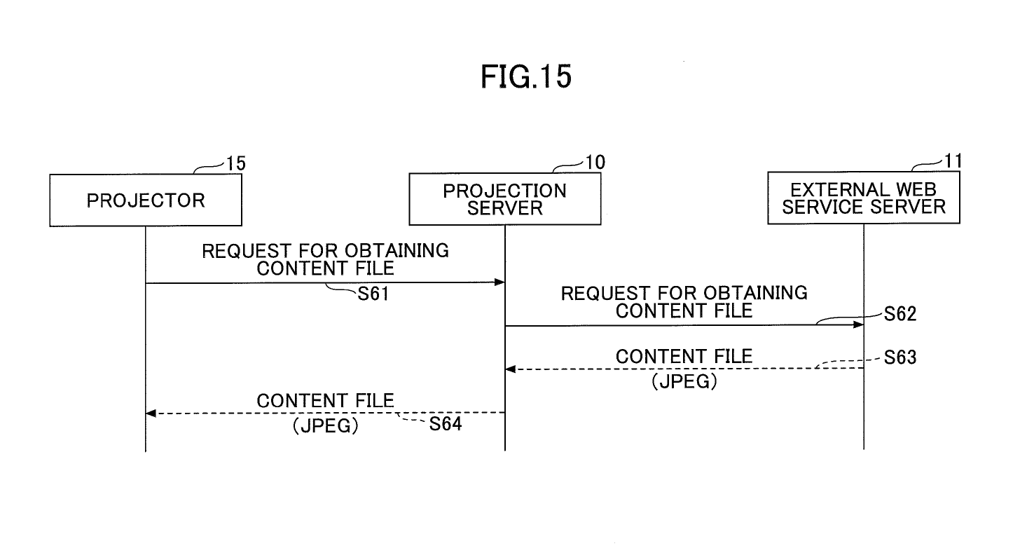

The operation of providing the content file in step S33 is performed by the cooperation of the projector 15 and the external service. Thus, the operation of providing the content file in step S33 is explained with reference to a sequence diagram shown in FIG. 15.

FIG. 15 is a sequence diagram showing an example of an operation of providing the content file in step S33 of FIG. 12. In FIG. 15, the external Web service server 11 is exemplified as an example of the content providing apparatus which provides the external service. FIG. 15 shows a case in which the content file stored in the external Web service server 11 is in a format (for example, JPEG format or the like) for which the projector 15 is capable of directly projecting.

In step S61, the projection server 10 receives a request for obtaining the content file of the external Web service server 11 by receiving the URL as shown in (E) of FIG. 5, for example. In step S62, the projection server 10 sends the request for obtaining the content file to the external Web service server 11.

In step S63, the projection server 10 receives a content file in a JPEG format, for example, from the external Web service server 11. Then, in step S64, the projection server 10 provides the content file in the JPEG format received from the external Web service server 11 to the projector 15.

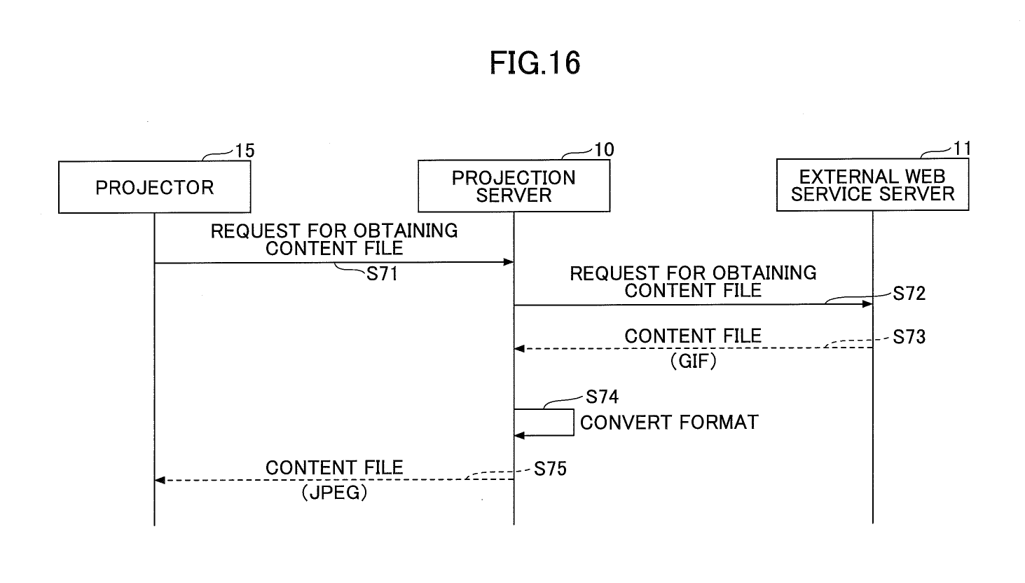

When the content file stored in the external Web service server 11 is in a format (for example, GIF format, PNG format or the like) for which the projector 15 is not capable of directly projecting, the operation of providing the content file in step S33 is performed in accordance with a sequence diagram shown in FIG. 16.

FIG. 16 is a sequence diagram showing another example of providing the content file in step S33 of FIG. 12. In step S71, the projection server 10 receives a request for obtaining the content file from the projector 15. In step S72, the projection server 10 sends the request for obtaining the content file to the external Web service server 11.

In step S73, the projection server 10 receives the content file in the GIF format which is not directly projectable by the projector 15, for example, from the external Web service server 11. In step S74, the projection server 10 converts the content file in the JPEG format which is directly projectable by the projector 15. Here, in step S74, the resolution of the content file may also be converted. In step S75, the projection server 10 provides the content file which is converted to the JPEG format to the projector 15.

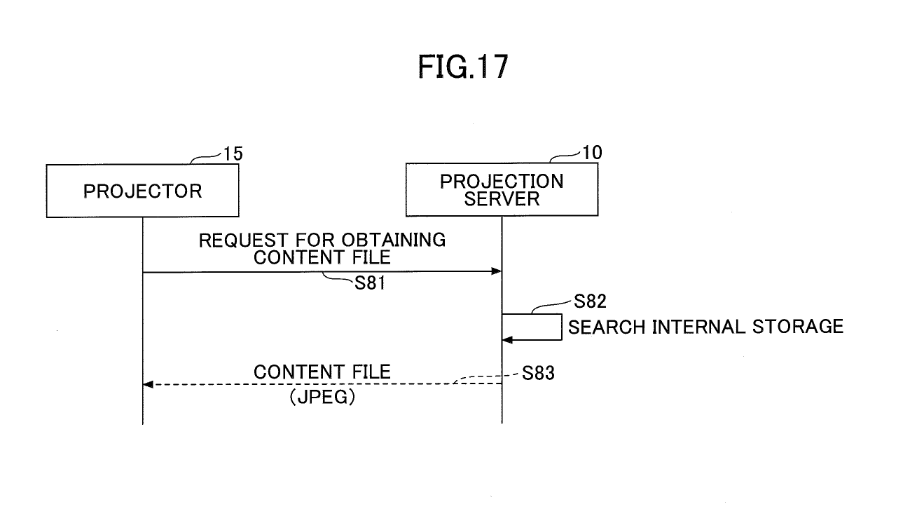

Further, when the content file which is stored in the internal storage in step S54 is selected from the file list screen in step S33, the operation of providing the content file is performed in accordance with a sequence diagram shown in FIG. 17.

FIG. 17 is a sequence diagram showing another example of an operation of providing the content file in step S33 of FIG. 12. In step S81, the projection server 10 receives the request for obtaining the content file stored in the internal storage in step S54 from the projector 15.

In step S82, the projection server 10 searches the content file stored in the internal storage, and reads out the content file which is requested from the projector 15. In step S83, the projection server 10 provides the content file in the JPEG format read out from the internal storage to the projector 15.

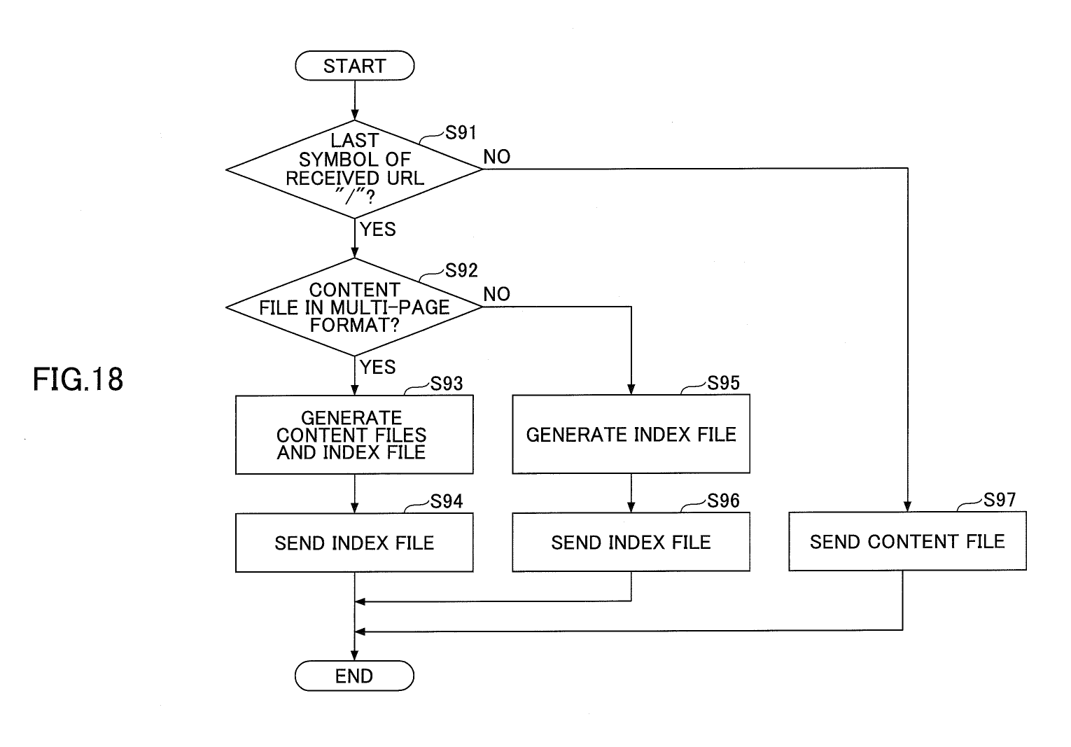

In the following, an operation of the external service controller 34c is explained in detail. FIG. 18 is a flowchart showing an example of an operation of the external service controller 34c. In step S31, the external service controller 34c determines whether the last symbol of the received URL is “/”. When the last symbol of the received URL is “/”, the external service controller 34c determines that it is the request for obtaining the index file and performs a process in step S92.

In step S92, the external service controller determines whether the received request for obtaining the index file is the subdirectory indicating the content file (the content file in the multi-page format).

When the request for obtaining the index file is for the content file in the multi-page format, in step S93, the external service controller 34c generates the numbers of content files corresponding to the pages in accordance with the operation explained above with reference to steps S54 to S55 in FIG. 14 and generates an index file in which the numbers of the content files corresponding to the pages are listed. In step S94, the external service controller 34c provides the index file to the projector 15 in accordance with the operation explained above with reference to step S56 in FIG. 14.

On the other hand, in step S92, when the request for obtaining the index file is not for the content file in the multi-page format, the external service controller 34c performs a process in step S95. In step S95, the external service controller 34c generates an index file in which the content file in the subdirectory is listed. In step S96, the external service controller 34c provides the generated index file to the projector 15.

Further, in step S91, when the last symbol of the received URL is not “/”, the external service controller 34c determines that it is the request for obtaining the content file, and performs a process in step S97. In step S97, the external service controller 34c performs the processes shown in FIG. 15 to FIG. 17 and sends the content file to the projector 15.

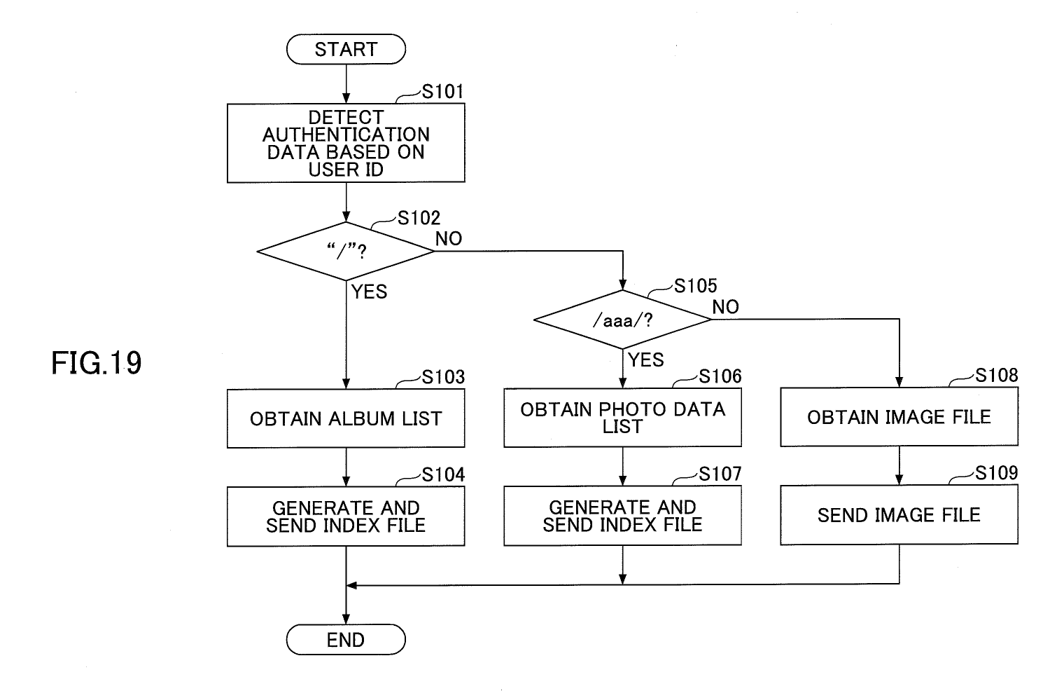

When the external service is a photo storage service in which photo data can be stored in plural albums, the operation of the external service controller 34c is performed in accordance with a flowchart shown in FIG. 19, for example. FIG. 19 is a flowchart showing another example of an operation of the external service controller 34c. FIG. 19 shows an example in which the albums are shown as subdirectories.

In step S101, the external service controller 34c detects authentication data of the external service which is in correspondence with the user ID from the user management unit 37. The authentication data will be explained in “Cooperation between projection server 10 and external service” later. The detected authentication data of the external service is used for authentication in the following processes. In step S102, the external service controller 34c determines whether the last symbol of the URL path in the external service included in the received URL is “/”.

When the last symbol of the URL path in the external service included in the received URL is “/”, in step S103, the external service controller 34c obtains the index file of the album list from the external Web service server 11 in accordance with the processes explained above with reference to steps S42 to S43 in FIG. 13. Then, in step S104, the external service controller 34c generates an index file including the album list in accordance with the processes explained above with reference to steps S44 to S45 in FIG. 13, and sends the index file to the projector 15.

On the other hand, in step S102, when the last symbol of the URL path in the external service included in the received URL is not “/”, the external service controller 34c performs a process in step S105. In step S105, the external service controller determines whether the last part of the URL path in the external service included in the received URL matches a pattern including a character string indicating an album (“aaa” in FIG. 19).

When the last part of the URL path in the external service included in the received URL matches the pattern, in step S106, the external service controller 34c obtains an index file of a list of photo data in the album “aaa” in accordance with the processes explained above with reference to steps S42 to S43 in FIG. 13 from the external Web service server 11.

Then, in step S107, the external service controller 34c generates an index file including the list of photo data (image files) in the album in accordance with the processes explained above with reference to steps S44 to S45 in FIG. 13, and sends the index file to the projector 15.

On the other hand, in step S105, when the last part of the URL path in the external service included in the received URL does not match the pattern, in other words, when it is data indicating an image file (for example, “/aaa/xxx.jpg”), in step S108, the external service controller 34c obtains the image file from the external Web service server 11 in accordance with the processes explained above with reference to steps S62 to S63 in FIG. 15. Then, in step S109, the external service controller 34c sends the image file to the projector 15 in accordance with the process explained above with reference to step S64 in FIG. 15.

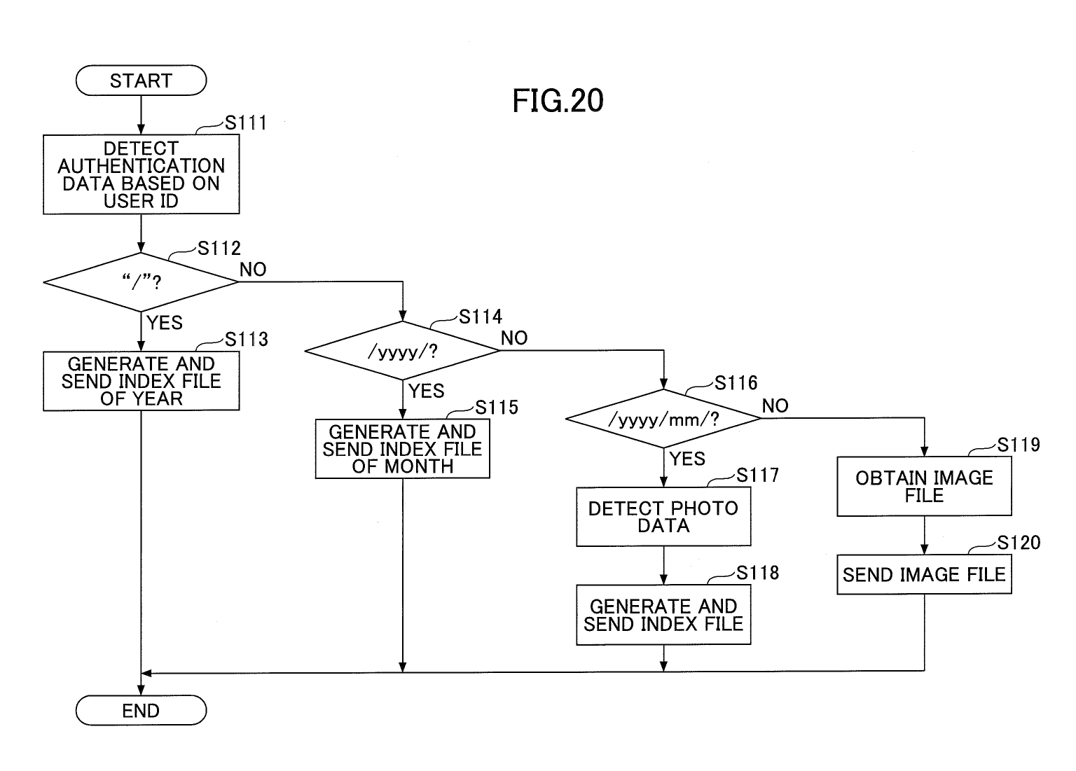

Although an example in which the albums are shown as subdirectories is shown in FIG. 19, instead, sets of year and month may be shown as subdirectories as shown in FIG. 20. FIG. 20 is a flowchart showing an example of another operation of the external service controller 34c.

In step S111, the external service controller 34c detects the authentication data of the external service in correspondence with the user ID from the user management unit 37. The detected authentication data of the external service is used for authentication in the following processes. In step S112, the external service controller 34c determines whether the last symbol of the URL path in the external service included in the received URL is “/”.

When the last symbol of the URL path in the external service included in the received URL is “/”, in step S113, the external service controller 34c generates an index file including a year list in accordance with the processes explained above with reference to steps S44 to S45 in FIG. 13, and sends the index file to the projector 15.

For example, the index file including the year list may include subdirectories for the last ten years and a subdirectory of the older years, or subdirectories for every predetermined numbers of years (for example, every five years).

On the other hand, in step S112, when the last symbol of the URL path in the external service included in the received URL is not “/”, the external service controller 34c performs a process in step S114. In step S114, the external service controller 34c determines whether the last part of the URL path in the external service included in the received URL matches a pattern including a character string indicating a year (“yyyy” in FIG. 20).

When the last part of the URL path in the external service included in the received URL matches the pattern, in step S115, the external service controller 34c generates an index file including a month list of the year “yyyy” in accordance with the processes explained above with reference to steps S44 to S45 in FIG. 13, and sends the index file to the projector 15.

For example, the index file including the month list may include subdirectories of all of the months, or every predetermined numbers of months (for example, every three months).

On the other hand, when the last part of the URL path in the external service included in the received URL does not match the pattern including the character string indicating the year, the external service controller 34c performs a process in step S116. In step S116, the external service controller 34c determines whether the URL path in the external service included in the received URL matches a pattern including a character string indicating a year and a month (“yyyy/mm” in FIG. 20, respectively).

When the last part of the URL path in the external service included in the received URL matches the pattern, in step S117, the external service controller 34c obtains an index file of photo data for which time stamps are the year “yyyy” and the month “mm” from the external Web service server 11 in accordance with the processes explained above with reference to steps S42 to S43 in FIG. 13.

Then, in step S118, the external service controller 34c generates an index file in which a list of photo data (image file) for which the time stamps are the year “yyyy” and the month “mm” is included in accordance with the processes explained above with reference to steps S44 to S45 in FIG. 13, and sends the index file to the projector 15.

On the other hand, in step S116, when the last part of the URL path in the external service included in the received URL does not match the pattern including the character string indicating the year and the month, in other words, when it is data indicating an image file (for example, “/yyyy/mm/xxx.jpg”), in step S119, the external service controller 34c obtains the image file from the external Web service server 11 in accordance with the processes explained above with reference to steps S62 to S63 in FIG. 15. Then, in step S120, the external service controller 34c sends the image file to the projector 15 in accordance with the process explained above with reference to step S64 in FIG. 15.

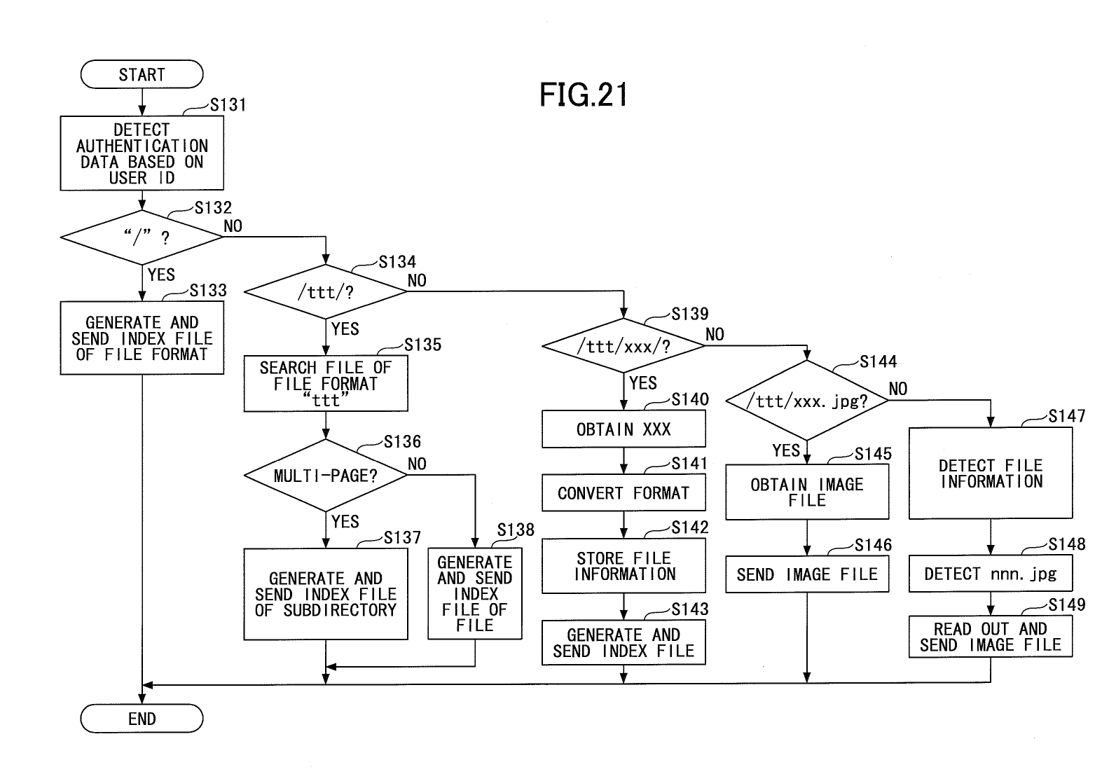

Further, when the external service is a document storage service, for example, the operation of the external service controller 34c is performed in accordance with a flowchart shown in FIG. 21. FIG. 21 is a flowchart showing another example of an operation of the external service controller 34c. FIG. 21 shows an example of the external service in which plural formats of files are stored.

In step S131, the external service controller 34c detects the authentication data of the external service in correspondence with the user ID from the user management unit 37. The detected authentication data of the external service is used for authentication in the following processes. In step S132, the external service controller 34c determines whether the last symbol of the URL path in the external service included in the received URL is “/”.

When the last symbol of the URL path in the external service included in the received URL is “/”, in step S133, the external service controller 34c generates an index file in which a list of file formats (for example, JPEG, PDF, PPT or the like) is included in accordance with the processes explained above with reference to steps S44 to S45 in FIG. 13, and sends the index file to the projector 15.

On the other hand, in step S132, when the last symbol of the URL path in the external service included in the received URL is not “/”, the external service controller 34c performs a process in step S134.

In step S134, the external service controller 34c determines whether the last part of the URL path in the external service included in the received URL matches a pattern including a character string indicating a file format (“ttt” in FIG. 21). When the last part of the URL path in the external service included in the received URL matches the pattern, in step S135, the external service controller 34c searches a file of a file format “ttt” stored in the external Web service server 11.

In step S136, the external service controller 34c determines whether the file format “ttt” is the multi-page format (for example, PDF, PPT or the like). When it is the multi-page format, in step S137, the external service controller 34c generates an index file in which a list of subdirectories indicating files, is included. The external service controller 34c provides the generated index file to the projector 15.

When it is not the multi-page format, in step S138, the external service controller 34c generates an index file in which a list of files is included, and provides the index file to the projector 15.

On the other hand, in step S134, when the last part of the URL path in the external service included in the received URL does not match the pattern including the character string indicating a file format, the external service controller 34c performs a process in step S139. In step S139, the external service controller 34c determines whether the last part of the URL path in the external service included in the received URL matches a pattern including a subdirectory indicating a multi-page file (“xxx” in FIG. 21).

In step S140, when the last part of the URL path in the external service included in the received URL matches the pattern, the external service controller 34c obtains the multi-page file specified by the subdirectory name “xxx” in accordance with the processes as explained above with reference to steps S52 to S53 in FIG. 14 from the external Web service server 11.

In step S141, the external service controller 34c converts the format of the obtained file in accordance with the process with respect to step S54 in FIG. 14, and stores the files in the converted format (for example, JPEG format or the like) corresponding to pages in the internal storage.

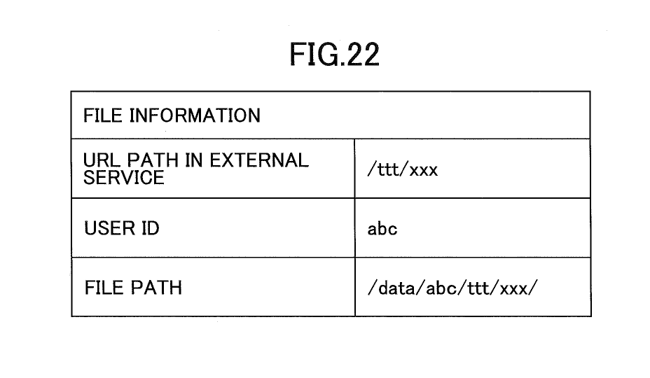

In step S142, the external service controller 34c generates file information as shown in FIG. 22. FIG. 22 is a view showing an example of the file information. The file information shown in FIG. 22 includes the URL path in the external service, the user ID, and a path to the file stored in the internal storage, which are in correspondence with each other.

Referring back to FIG. 21, in step S143, the external service controller 34c generates an index file of the files stored in the internal storage in the JSON format, for example, and provides the index file to the projector 15.

On the other hand, in step S139, when the last part of the URL path in the external service included in the received URL dose not match the pattern including the subdirectory indicating the multi-page file, the external service controller 34c performs a process in step S144. In step S144, the external service controller 34c determines whether the last part of the URL path in the external service included in the received URL matches a pattern of data indicating a file format+data indicating a image file (“/ttt/xxx.jpg” in FIG. 21).

When the last part of the URL path in the external service included in the received URL matches the pattern, in step S145, the external service controller 34c obtains the image file from the external Web service server 11 in accordance with the processes explained above with reference to steps S62 to S63 in FIG. 15. In step S146, the external service controller 34c sends the image file to the projector 15 in accordance with the process explained above with reference to step S64 in FIG. 15.

On the other hand, in step S144, when the last part of the URL path in the external service included in the received URL does not match the pattern “/ttt/xxx.jpg”, in other words, when it is data indicating an image file (page) in the multi-page file (for example, “/ttt/xxx/nnn.jpg”), the external service controller 34c performs a process in step S147. In step S147, the external service controller 34c detects the path to the file stored in the internal storage in the file information based on the user ID and the URL path in the external service (/ttt/xxx).

In step S148, the external service controller 34c detects an image file, for example, “nnn.jpg” from the directory of the detected file path, and reads out the image file which is requested to be obtained from the internal storage. In step S149, the external service controller 34c provides the read out image file to the projector 15.

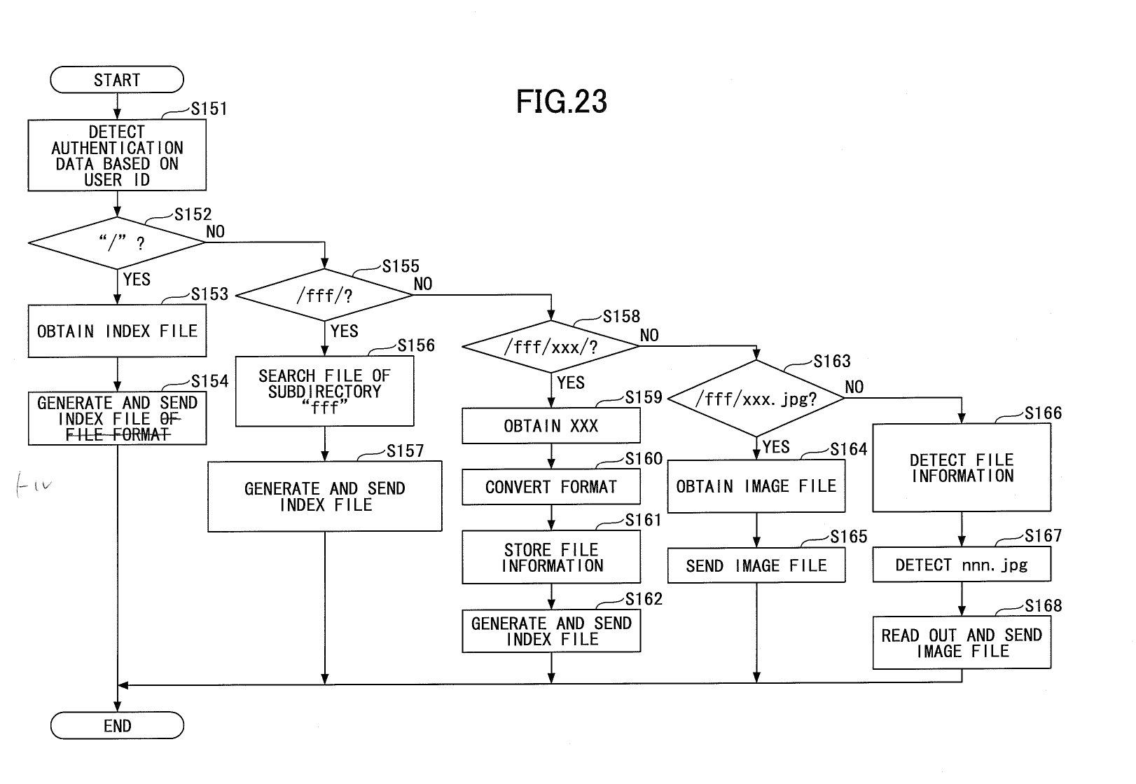

Further, when the external service is the document storage service, for example, the external service controller 34c may provide a list of subdirectories of a layer which is generated at a document storage service side in the file list screen as subdirectories, as shown in a flowchart in FIG. 23. FIG. 23 is a flowchart showing an example of another operation of the external service controller 34c.

In step S151, the external service controller 34c detects the authentication data of the external service in correspondence with the user ID from the user management unit 37. The detected authentication data of the external service is used for authentication in the following processes. In step S152, the external service controller 34c determines whether the last symbol of the URL path in the external service included in the received URL is “/”.

When the last symbol of the URL path in the external service included in the received URL is “/”, in step S153, the external service controller 34c obtains an index file in which a list of subdirectories generated at the document storage service side is included from the external Web service server 11. Then, in step S154, the external service controller 34c generates an index file in which the list of subdirectories generated at the document storage service is included, and sends the index file to the projector 15.

On the other hand, in step S152, when the last symbol of the URL path in the external service included in the received URL is not “/”, the external service controller 34c performs a process in step S155.

In step S155, the external service controller 34c determines whether the last part of the URL path in the external service included in the received URL matches a pattern including a character string (“fff” in FIG. 22) indicating the subdirectory. When the last part of the URL path in the external service included in the received URL matches the pattern, in step S156, the external service controller 34c searches for a file in the external Web service server 11 by designating the subdirectory “fff”.

In step S157, the external service controller 34c generates an index file of a list in which the multi-page files are expressed as subdirectories and the files which are not the multi-page files are expressed as files, among the files stored in the external Web service server 11. Then, the external service controller 34c provides the generated index file to the projector 15.

When the last part of the URL path in the external service included in the received URL does not match the pattern including the character string indicating the subdirectory, the external service controller 34c performs a process in step S158. The processes of steps S158 to 168 in FIG. 22 are the same as the processes of steps S139 to S149 in FIG. 21, and the explanation to which is not repeated.

(Operation of Internal Storage Service Controller 34b)

An operation of the internal storage service controller 34b mainly includes uploading a file, sending a file and deleting a file. The operations of the internal storage service controller 34b of uploading a file, sending a file and deleting a file are explained in the following.

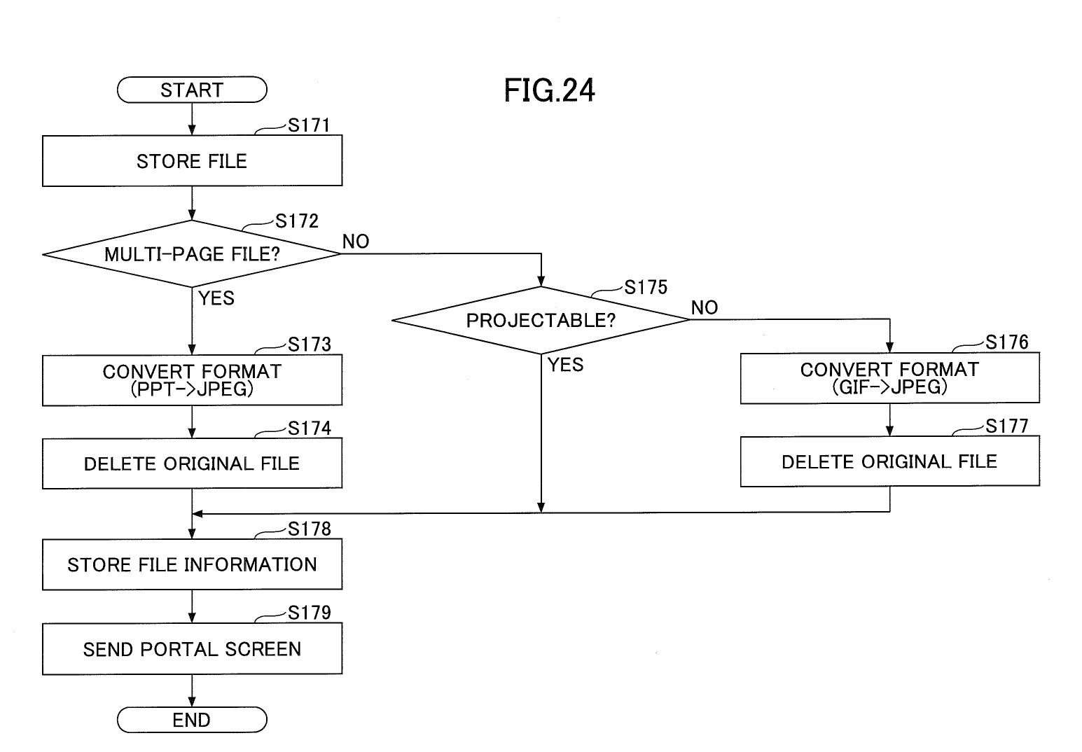

FIG. 24 is a flowchart showing an example of an operation of uploading a file. The internal storage service controller 34b has a function to upload a file, and is capable of storing the uploaded file in the internal storage from the browser on the PC or the like.

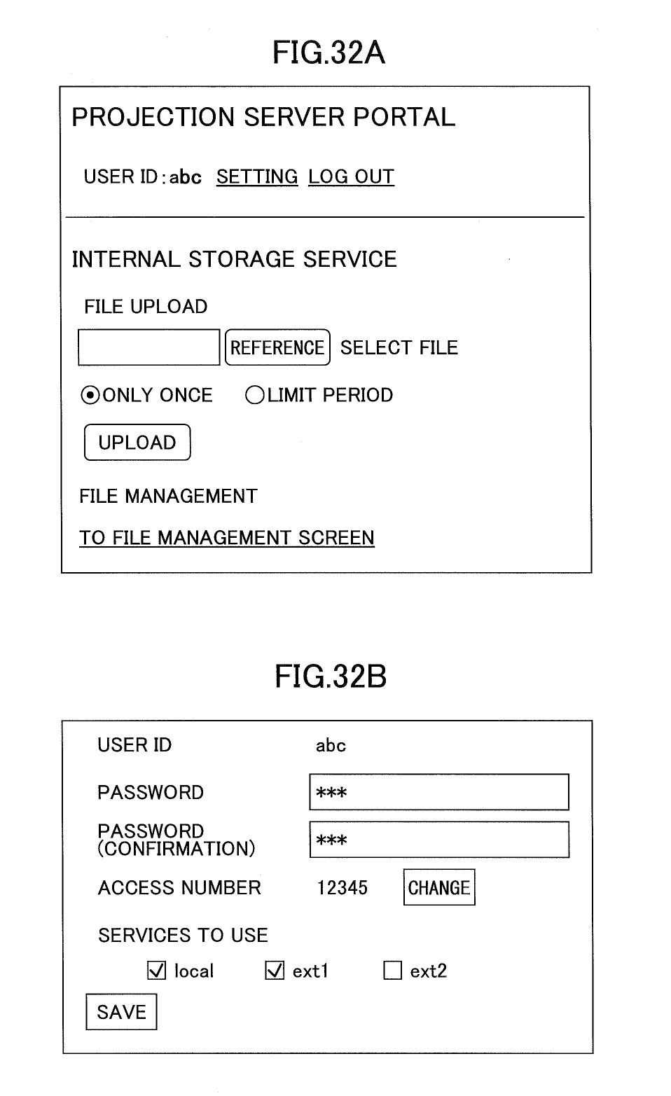

For example, the browser on the PC is capable of requesting uploading for a file by performing a POST request of the file to the URL for uploading (for example, “http://projectionportal.example.com/upload”). The operator performs this request by logging into a portal page shown in FIG. 32A, which will be explained later, and clicking an upload button after selecting a file and a mode.

Upon receiving the URL for uploading from the dispatcher unit 32, in step S171, the internal storage service controller 34b stores the file which is uploaded by the POST request in the internal storage.

In step S172, the internal storage service controller 34b determines whether the file stored in the internal storage is the multi-page file. When it is the multi-page file, in step S173, the internal storage service controller 34b converts the multi-page file to a format projectable by the projector 15 such as the JPEG format. In step S174, the internal storage service controller 34b deletes the multi-page file (original file).

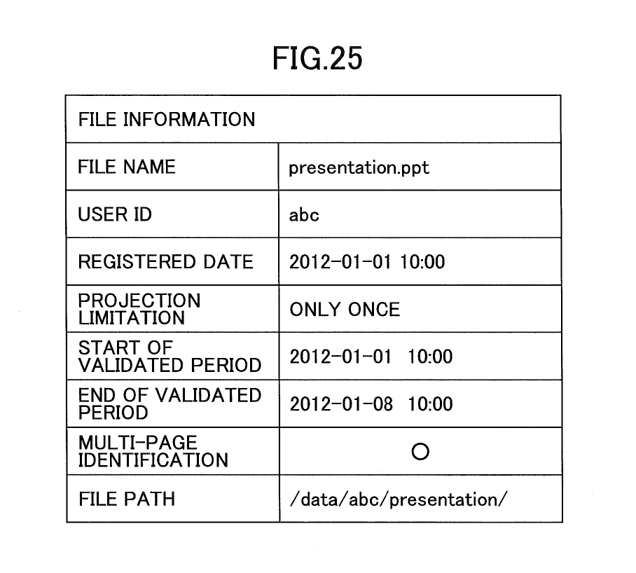

Then, in step S178, the internal storage service controller 34b registers the file information as shown in FIG. 25. In the user ID, the ID of a user who is logged in is registered. Then, in step S179, the internal storage service controller 34b controls to display a portal screen in the browser on the PC which has requested to upload the file.

FIG. 25 is a view showing another example of the file information. The file information shown in FIG. 25 includes items such as a file name, user ID, registered date, projection limitation, start and end of a validated period, multi-page identification, and a file path, which are in correspondence with each other.

The projection limitation includes “only once”, “only within a limited period”, “device limitation” or the like. When the projection limitation is set as “only once”, the start and end of validated period may be set within 1 week from the registered date, for example, and when the projection limitation is set as “only within a limited period”, the start and end of validated period may be set as dates designated when the file is being uploaded. When the content file is in a multi-page format, the file path becomes a directory path.

In step S172, when the file is not the multi-page file, the internal storage service controller 34b performs a process in step S175. In step S175, the internal storage service controller 34b determines whether the file stored in the internal storage is the format directly projectable by the projector 15. When the file is the format directly projectable by the projector 15, the internal storage service controller 34b performs the above explained processes in steps S178 and S179.

When the format is not the format directly projectable by the projector 15 in step S175, the internal storage service controller 34b converts the format of the file into a format directly projectable by the projector 15 such as the JPEG format or the like in step S176. Then, in step S177, the internal storage service controller 34b deletes the original file which is in the format not directly projectable by the projector 15. When the format is the format directly projectable by the projector 15, the internal storage service controller 34b performs the processes of steps S178 and S179 as explained above.

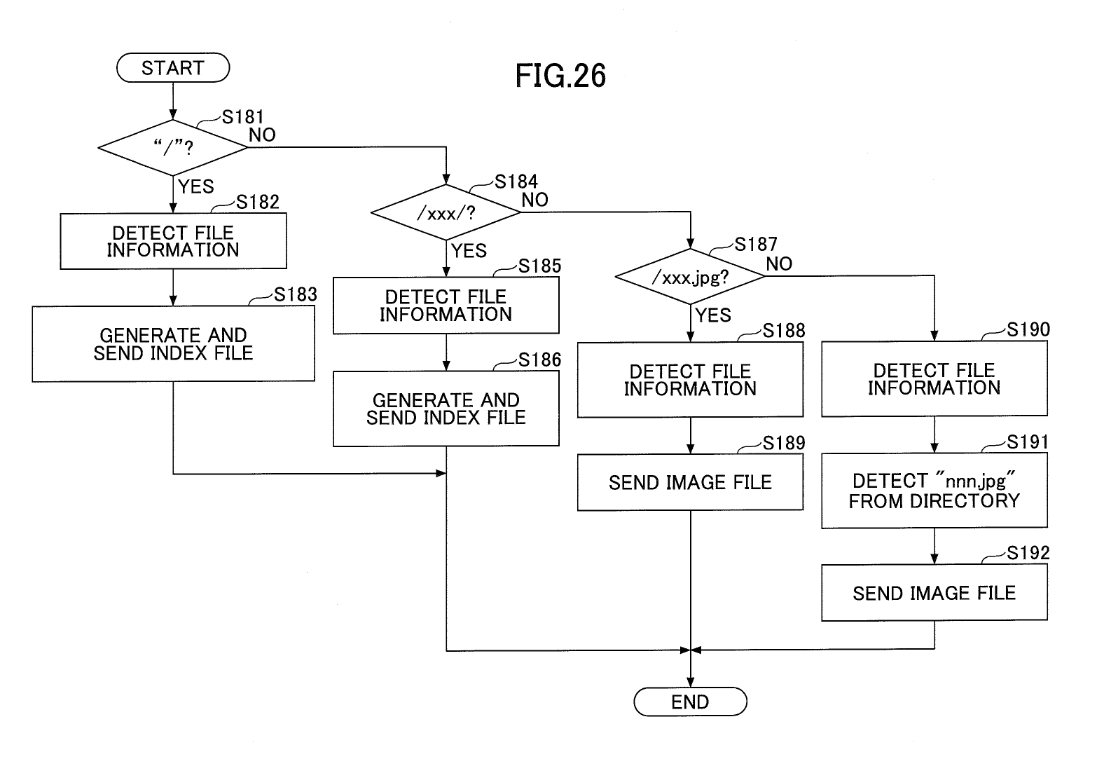

FIG. 26 is a flowchart showing an example of an operation of sending a file. For example, the projector 15 is capable of requesting sending a file by performing a get request of a file at the URL (for example, http://projection.example.com/12345/local/presentation.ppt/file001.jpeg).

The part of the above URL “/presentation.ppt/file001.jpeg” is referred to as a URL path in the internal storage. Then, in step S181, the internal storage service controller 34b determines whether the last symbol of the URL path in the internal service included in the received URL is “/”.

When the last symbol of the URL path in the internal service included in the received URL is “/”, in step S182, the internal storage service controller 34b detects the file information based on the user ID. The user ID can be obtained from the user information based on the access number.

In step S183, the internal storage service controller 34b generates an index file of a list in which the multi-page files are expressed as subdirectories and the files which are not the multi-page files are expressed as files, among the files stored in the internal storage. The internal storage service controller 34b provides the generated index file to the projector 15. At this time, the index file may not include a file for which the validated period is not started.

On the other hand, in step S181, when the last symbol of the URL path in the internal service included in the received URL is not “/”, the internal storage service controller 34b performs a process in step S184.

In step S184, the internal storage service controller 34b determines whether the last part of the URL path in the internal service included in the received URL matches a pattern including a subdirectory indicating a multi-page file (“xxx” in FIG. 26). When the last part of the URL path in the internal storage matches the pattern, in step S185, the internal storage service controller 34b detects the file information based on the user ID and the file name.

In step S186, the internal storage service controller 34b generates an index file containing a list of files in the directory specified by the file path included in the detected file information, and sends the generated index file to the projector 15.

When the last part of the URL path in the internal storage does not match the pattern including the subdirectory, the internal storage service controller 34b performs a process in step S187. In step S187, the internal storage service controller 34b determines whether the last part of the URL path in the internal service included in the received URL matches a pattern including the image file (“/xxx.jpg” in FIG. 26).

When the last part of the URL path in the internal storage matches the pattern, in step S188, the internal storage service controller 34b detects the file information based on the user ID and the file name. In step S189, the internal storage service controller 34b reads out the image file specified by the file path included in the detected file information, and sends the read out image file to send to the projector 15.

When the last part of the URL path in the internal storage does not match the pattern “/xxx.jpg”, in other words, when it is data indicating an image file in a multi-page file (for example, “/xxx/nnn.jpg”), the internal storage service controller 34b performs a process in step S190. In step S190, the internal storage service controller 34b detects the file information based on the user ID and the file name “xxx”.

In step S191, the internal storage service controller 34b detects the image file “nnn.jpg” based on the directory specified by the file path included in the detected file information. Then, in step S192, the external service controller 34b reads out the image file which is requested to be read out from the internal storage, and provides the image file to the projector 15.

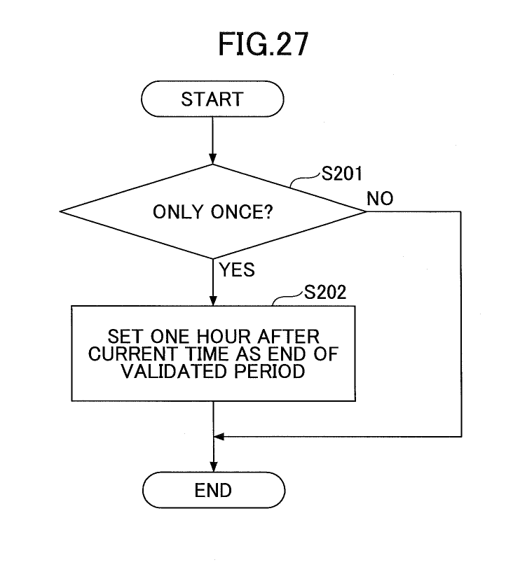

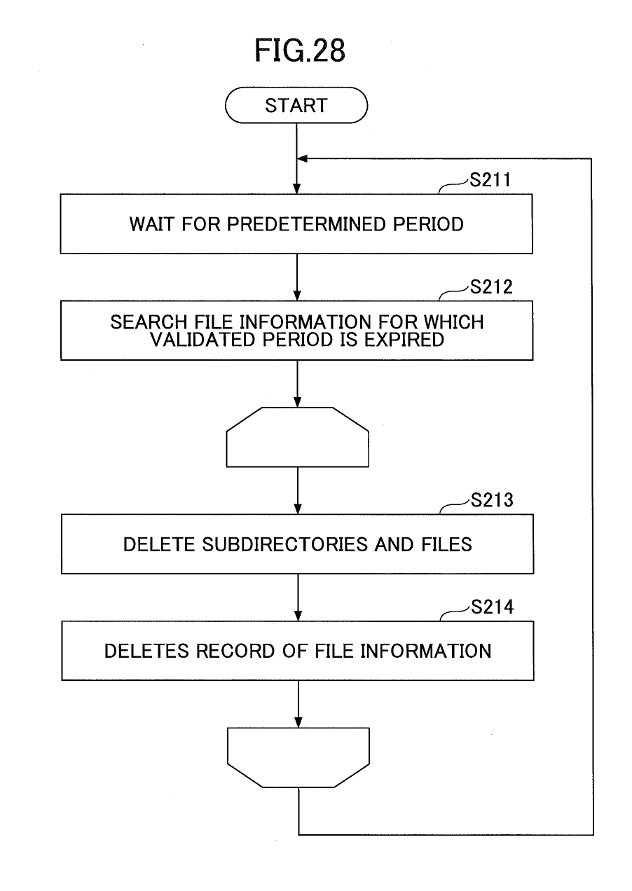

An operation of deleting files by the internal storage service controller 34b is performed in accordance with flowcharts shown in FIG. 27 and FIG. 28, for example. FIG. 27 is a flowchart showing an operation of setting an end of the validated period of the file information, which is performed after the processes of steps S186, S189 and S192 in FIG. 26 are performed. FIG. 28 is a flowchart showing an operation of deleting a file the validated period of which has ended, which is performed at every predetermined period by a timer process.

Referring to FIG. 27, in step S201, the internal storage service controller 34b determines whether the projection limitation of the file stored in the internal storage is “only once”. When the projection limitation is “only once”, in step S202, the internal storage service controller 34b sets the end of the validated period of the file information to be one hour after the current time, for example. When the projection limitation is not “only once”, the internal storage service controller 34b does not perform the process of step S202.

Referring to FIG. 28, in step S211, the internal storage service controller 34b waits for a predetermined period. In step S212, the internal storage service controller 34b searches for file information for which the validated period is expired by referring to the end of the validated period in the file information. In step S213, the internal storage service controller 34b deletes the subdirectories and the files of the file paths included in the file information whose validated period is expired. In step S214, the internal storage service controller 34b deletes the record of the file information whose validated period is expired. The processes in steps S213 to S214 are performed for all of the file information whose validated periods are expired.

Although an example where the projection limitation is “only once” is shown in the flowchart in FIG. 27, the projection limitation may be set as “only n-th times”. In this case, a field indicating the number of times may be added to the file information shown in FIG. 25. When the projection limitation is set as “only n-th times”, the processes in steps S213 to S214 are performed after the projected number reaches the n-th times.

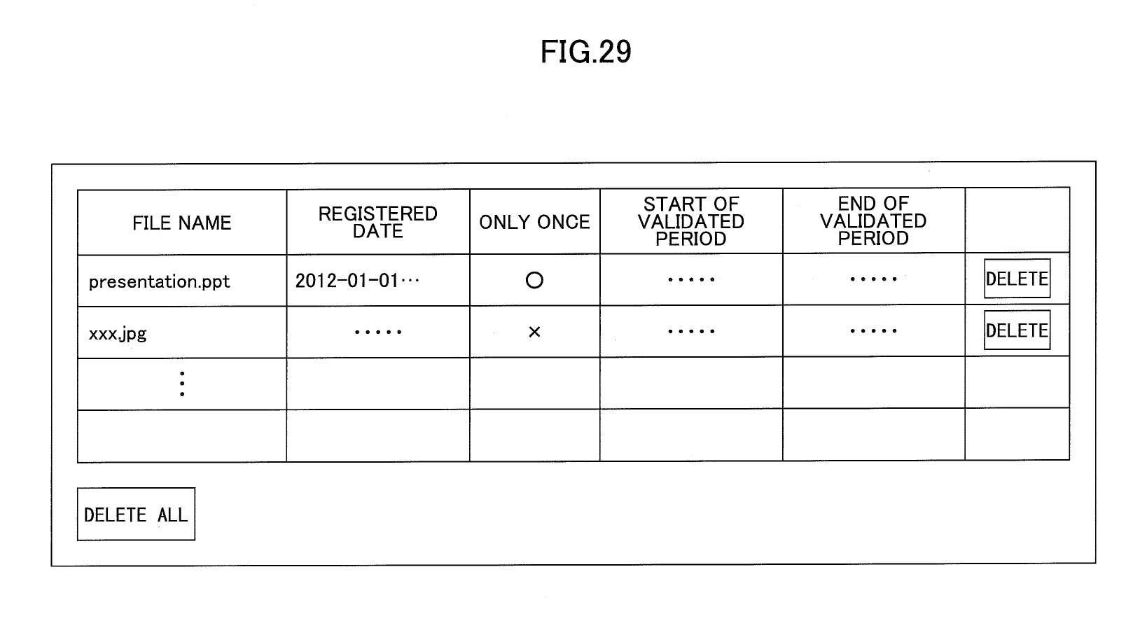

The operation of deleting the file by the internal storage service controller 34b may be, for example, performed by an instruction by the operator. The operator may instruct the PC to display a screen as shown in FIG. 29 by operating the browser on the PC to request to the URL for file management (for example, “http://projectionportal.example.com/filemgr”). The operator may log in a portal page, which will be explained later with reference to FIG. 32A, and clicks a “to file management screen” link to perform this operation.

Upon receiving the URL for file management from the dispatcher unit 32, the internal storage service controller 34b has the browser which has requested display the screen as shown in FIG. 29. FIG. 29 is a view showing a screen for accepting an instruction to delete a file from the operator. The operator instructs to delete the file from the screen displayed on the browser as shown in FIG. 29. The instruction for deleting the file accepted from the operator is sent from the browser to the internal storage service controller 34b. Then, the internal storage service controller 34b performs the processes in step S213 to S214 for the file for which the instruction for deleting the file is accepted.

### (Cooperation Between Projection Server 10 and External Service)

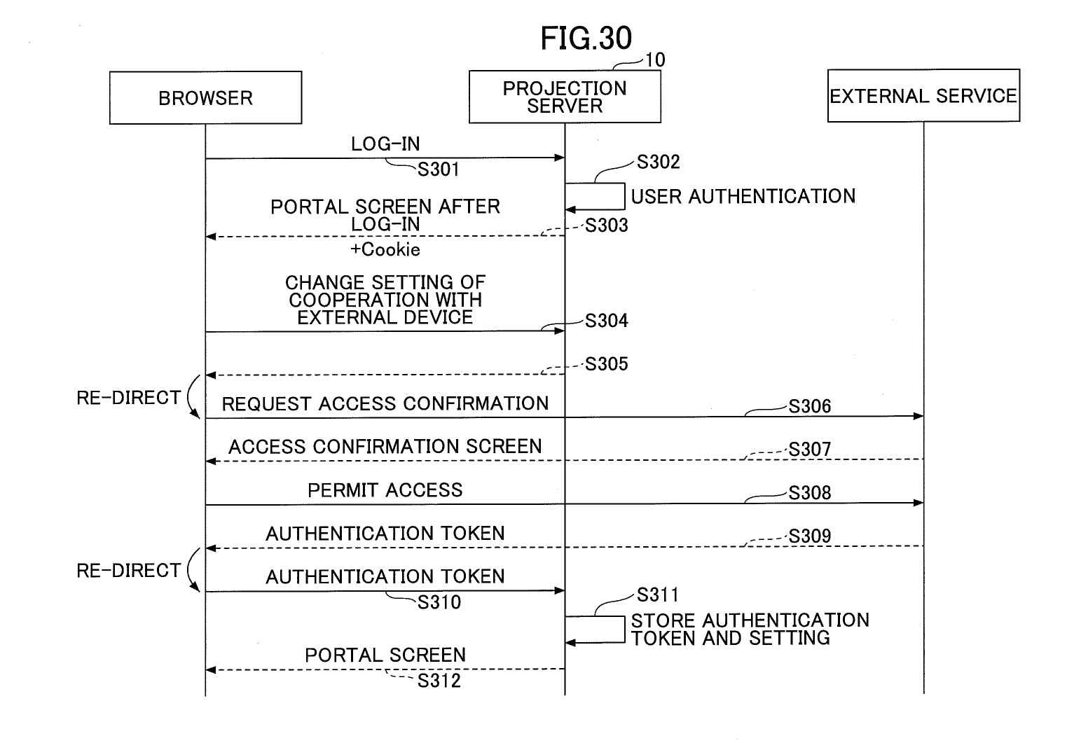

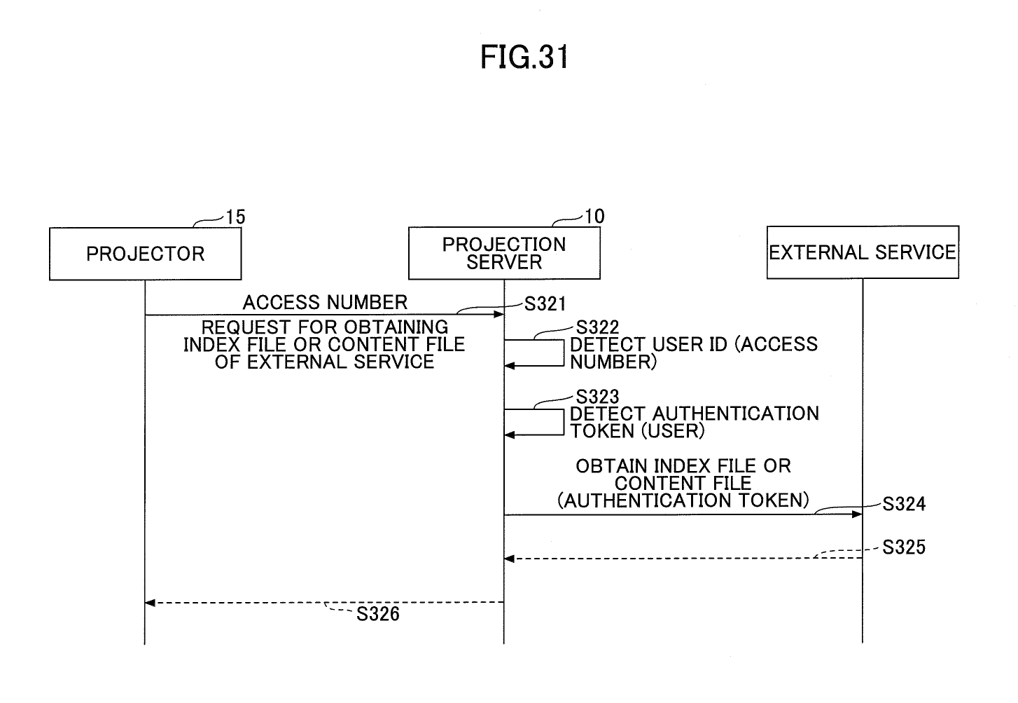

When the external service supports an interface between servers such as OAuth, Authsub or the like, the projection server 10 and the external service cooperate with each other in accordance with the processes shown in the sequence diagram in FIG. 30 and FIG. 31, for example. The OAuth and the Authsub are protocols for authentication each of which functions as a proxy of a user in user authentication to access a resource of the user in the Web server.

FIG. 30 is a sequence diagram showing an operation of setting performed by cooperation of the projection server 10 and the external service. FIG. 31 is a sequence diagram showing an operation of projection performed by cooperation of the projection server 10 and the external service.

The operator inputs user ID and a password by operating the browser on the PC. In step S301, the browser sends a request to log-in using the user ID and the password of the operator to the projection server 10. In step S302, the projection server 10 performs a user authentication using the user information.

When the user authentication succeeds, in step S303, the projection server 10 displays a portal screen after log-in on the browser. FIG. 32A is a view showing an example of a portal screen displayed after the operator logs in. The portal screen after log-in includes user ID of the user who is logging in, a setting link, a log out link, and a UI for an internal storage service. The UI for an internal storage service includes a file selection button for uploading a file, a mode selection button, a button for instructing upload, and the “to file management screen” link. When the operator clicks the setting link, the projection server 10 has the browser display a setting screen. FIG. 32B is a view showing an example of the setting screen. The setting screen includes user ID, a password, an access number and services to use. The access number may be generated by random digits when registering users, for example. The access number may be changed by clicking a “change” button in the setting screen.

When the operator operates check boxes of the services to use in the portal screen after log-in, for example, the setting of the cooperation with the external service can be changed.

Referring back to FIG. 30, in step S304, the browser sends a request for changing setting of cooperation with an external device to the projection server 10. In step S305, the projection server 10 sends information for confirming access to the external service for which the setting of cooperation is changed, the URL of the external service and a URL of a portal screen which is to be displayed after the access is confirmed, to the browser.

In step S306, the browser requests, by a re-direct, the URL of the external service for access confirmation. In step S307, the external service has the browser display an access confirmation screen. The operator inputs the authentication data of the external service in the access confirmation screen as well as permitting an access from the projection server 10 to the external service.

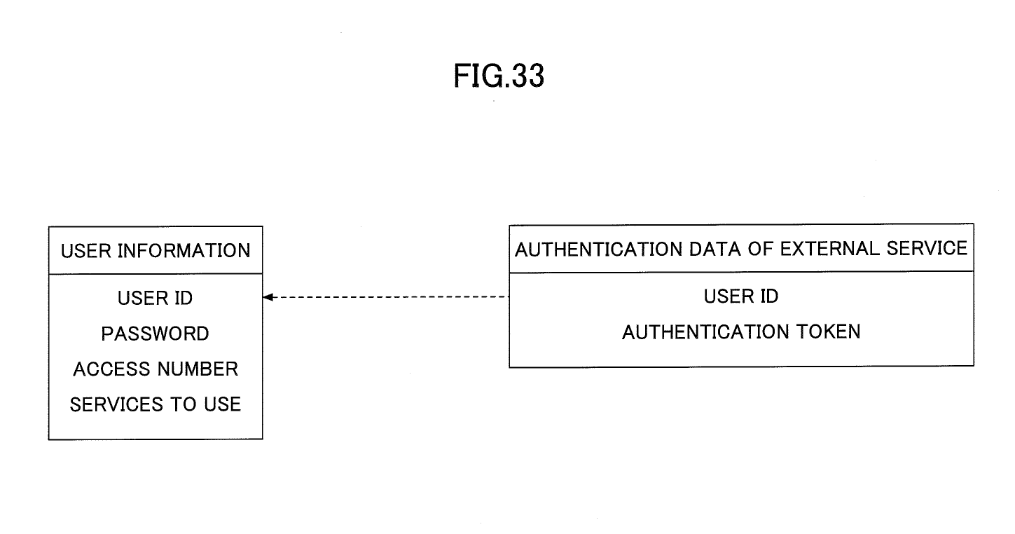

In step S308, the browser notifies the external service for the permission of access using the authentication data of the external service of the operator. In step S309, the external service returns an authentication token to the browser. In step S310, the browser sends the authentication token to the projection server 10, by a re-direct. In step S311, the projection server 10 stores the authentication token and the setting of the services to use as shown in FIG. 33, for example.

FIG. 33 is a view showing a correspondence between the user information and the authentication data of the external service. The user information (which is simplifying the user information shown in FIG. 9) and the authentication data of the external service shown in FIG. 33 are in correspondence with each other by the user ID. The authentication token is stored in the authentication data of the external service in correspondence with the user ID. Then, in step S312 in FIG. 30, the projection server 10 has the browser display a portal screen after the access confirmation.

When projecting the content file provided by the external service, the operator inputs the access number to the projector 15. Referring to FIG. 31, in step S321, the projector 15 sends a request for obtaining the index file or the content file of the external service using the access number.

In step S322, the projection server 10 detects the user ID from the user information based on the access number. In step S323, the projection server 10 detects the authentication token from the authentication data of the external service based on the user ID. In step S324, the projection server 10 sends a request for obtaining the index file or the content file to the external service using the authentication token.

In step S325, the external service sends the index file or the content file which is requested to the projection server 10. Then, in step S326, the projection server 10 sends the index file or the content file to the projector 15. Thus, the projector 15 can project the index file or the content file sent from the projection server 10.

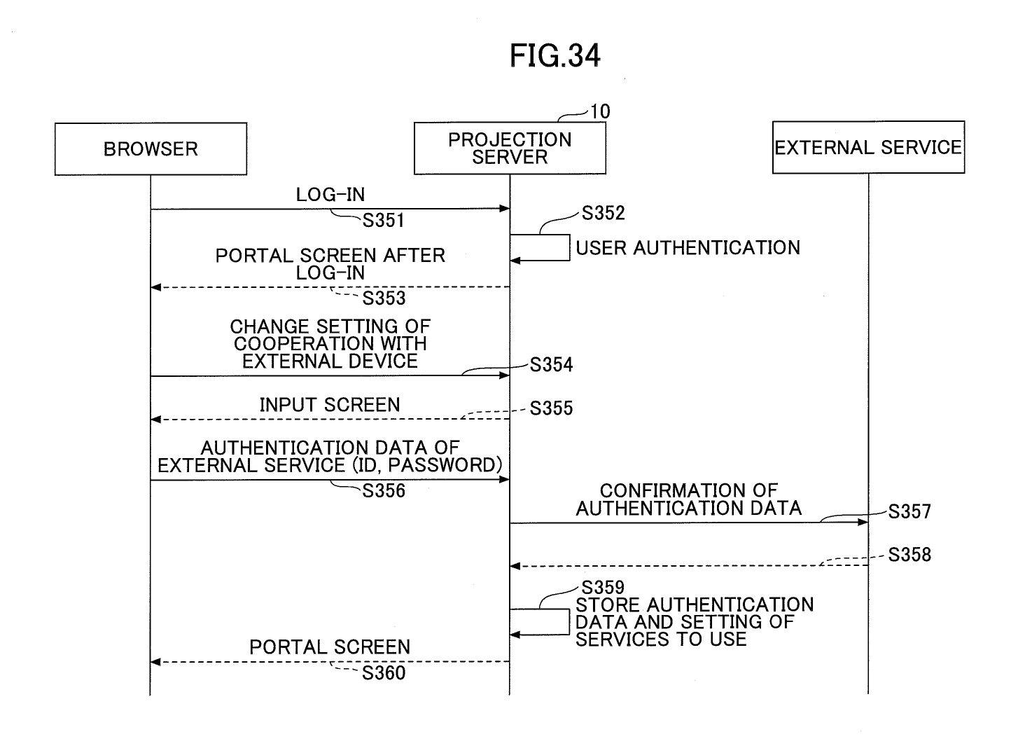

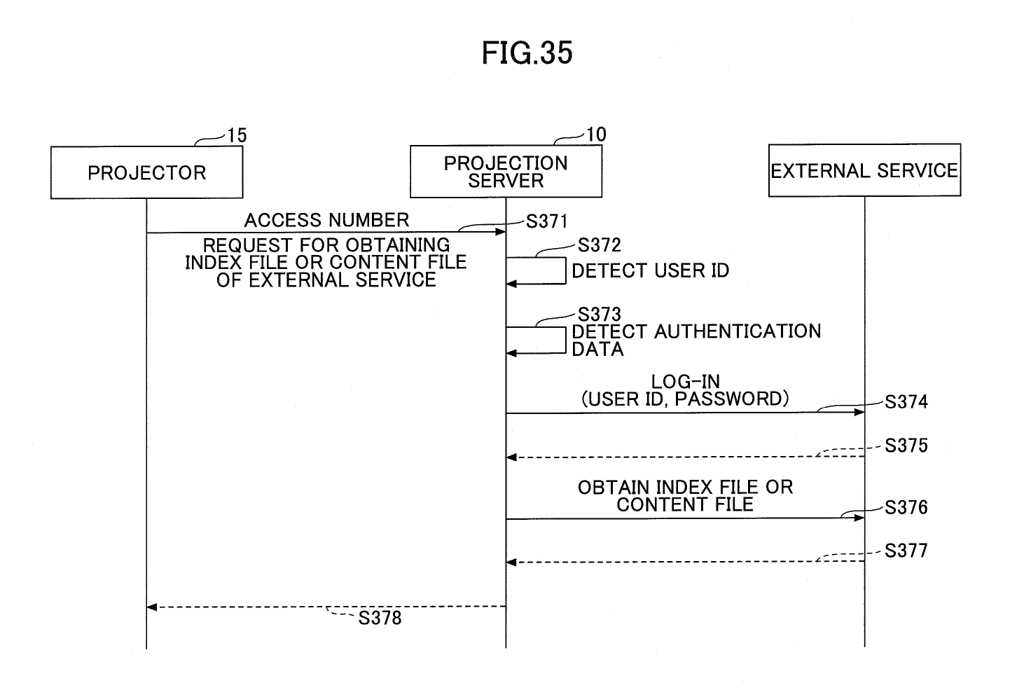

When the interface for cooperation between servers does not exist between the projection server 10 and the external service, the projection server 10 and the external service cooperate with each other in accordance with the processes shown in sequence diagrams in FIG. 34 and FIG. 35, for example.

FIG. 34 is a sequence diagram showing an operation of setting performed by cooperation of the projection server 10 and the external service. FIG. 35 is a sequence diagram showing an operation of projection performed by cooperation of the projection server 10 and the external service.

The processes of steps S351 to S354 are the same as the processes of steps S301 to S304 in FIG. 30, the explanation for which is not repeated. In step S355, the projection server 10 has the browser display an input screen for inputting the authentication data of the external service. The operator inputs the authentication data of the external service in the input screen.

In step S356, the browser sends the authentication data of the external service of the operator to the projection server 10. In step S357, the projection server 10 requests the external service to confirm the authentication data of the operator using the authentication data of the external service of the operator. In step S358, the projection server 10 receives a confirmed result of the authentication data of the external service of the operator from the external service.

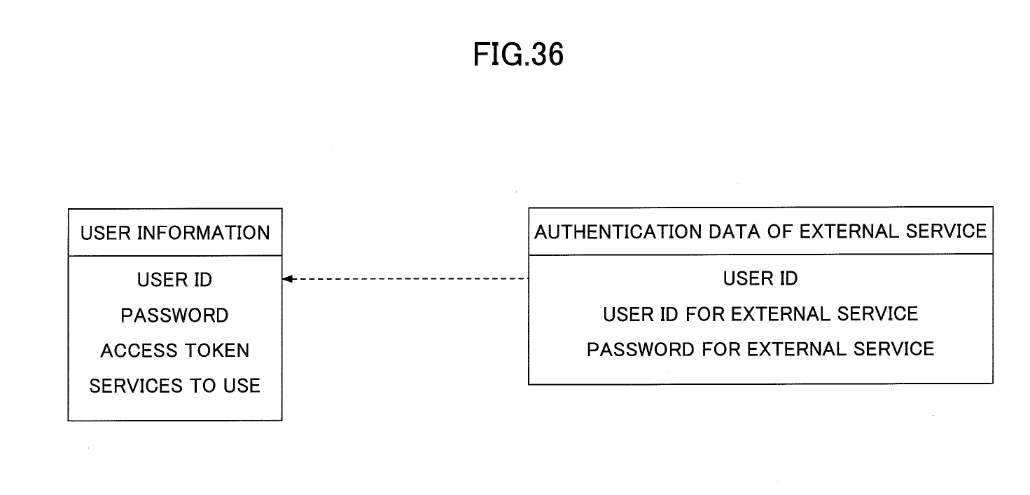

In step S359, when the authentication data of the external service of the operator is confirmed, the projection server 10 stores the authentication data of the external service and setting of the services to use as shown in FIG. 36, for example.

FIG. 36 is a view showing a correspondence between the user information (which is simplifying the user information shown in FIG. 9) and the authentication data of the external service. The user information and the authentication data of the external service shown in FIG. 36 are in correspondence with each other by the user ID. The user ID and the password of the external service as the authentication data of the external service are stored in correspondence with the authentication data of the external service with the user ID. Then, referring back to FIG. 34, in step S360, the projection server 10 has the browser display a portal screen.

When the content file provided by the external service is projected, the operator inputs the access number in the projector 15. Referring to FIG. 35, in step S371, the projector 15 requests obtaining an index file or a content file of the external service using the access number.

In step S372, the projection server 10 detects the user ID from the user information based on the access number. In step S373, the projection server 10 detects the user ID and the password of the external service from the authentication data of the external service based on the user ID. In step S374, the projection server 10 requests a log-in using the user ID and the password of the external service.

The external service performs user authentication using the user ID and the password. When the user authentication succeeds, in step S375, the external service sends information indicating success of the user authentication. In step S376, the projection server 10 sends a request for obtaining the index file or the content file to the external service.

In step S377, the external service sends the index file or the content file which is requested to the projection server 10. Then, in step S378, the projection server 10 sends the index file or the content file to the projector 15. Thus, the projector 15 is capable of projecting the index file or the content file which is sent from the projection server 10.

The storage server 12, the PC 13, and the image input output device 14, which are examples of the external service may have the following structure for cooperation with the projection server 10, for example. The following multifunction machine, the digital camera and the fixed camera are examples of the image input output device 14.

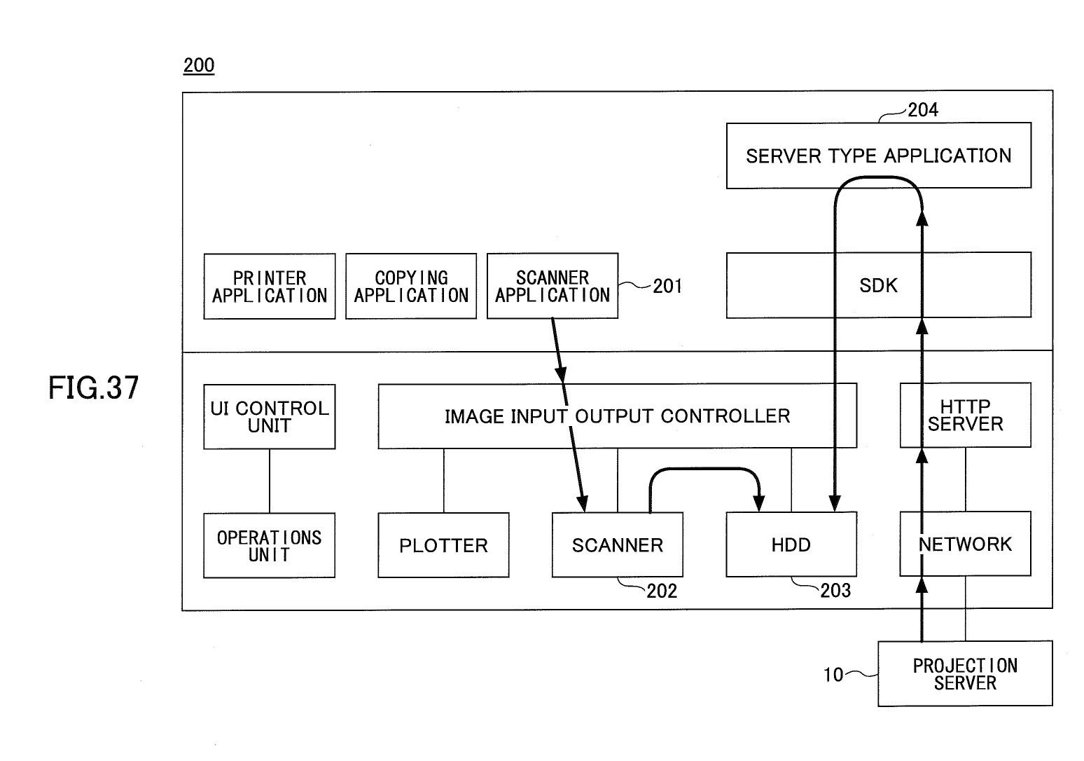

FIG. 37 is a block diagram showing an example of a multifunction machine 200 which cooperates with the projection server 10. The multifunction machine 200 includes a printer application, a copying application, a scanner application (201), a server type application (204), an SDK, a UI control unit, an operations unit, an image input output controller, a plotter, a scanner (202), a HDD (203), an HTTP server, a network interface and the like. In the multifunction machine 200, an image file scanned by the scanner application 201 and the scanner 202 is stored in the HDD 203.

The server type application 204 generates an index file of image files stored in the HDD 203 based on the request for obtaining the index file from the projection server 10, and sends the generated index file to the projection server 10. The server type application 204 obtains the image file stored in the HDD 203 based on the request for obtaining the image file from the projection server 10, and sends it to the projection server 10.

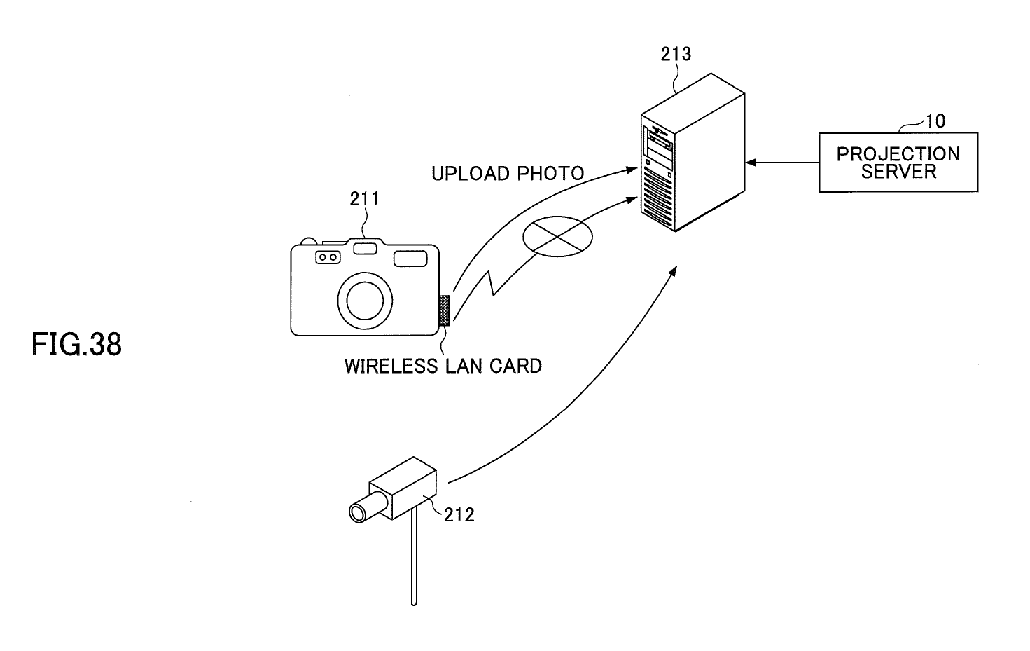

FIG. 38 is a schematic view showing a digital camera 211 and a fixed camera 212 which cooperate with the projection server 10. The digital camera 211 and the fixed camera 212 in FIG. 38 each upload an image file to a server apparatus 213 via a wireless LAN or a cable LAN.

The server apparatus 213 generates an index file of image files stored therein based on a request for obtaining the index file from the projection server 10, and sends it to the projection server 10. The server apparatus 213 sends an image file stored therein to the projection server 10 based on the request for obtaining an image from the projection server 10.

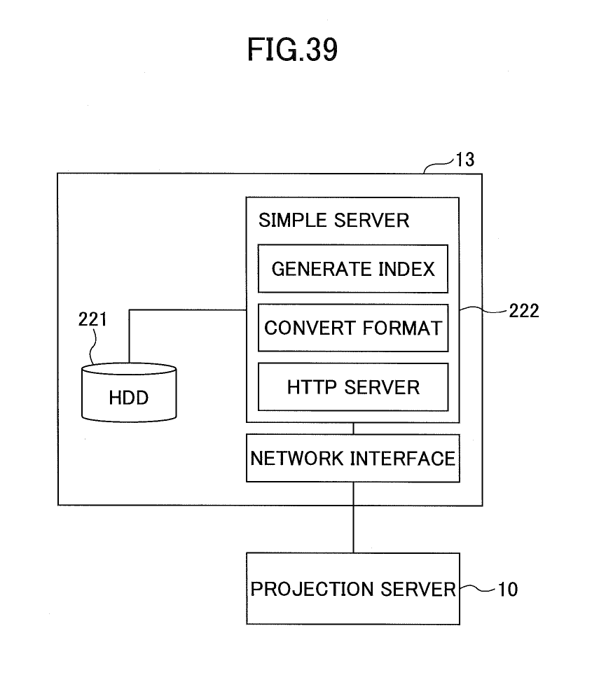

FIG. 39 is a block diagram showing an example of a structure of the PC 13 which cooperates with the projection server 10. The PC 13 includes a simple server 222 and a HDD 221. In the PC 13 in FIG. 39, an image file is stored in the HDD 221. The simple server 222 generates an index file of image files stored in the HDD 221 based on the request for obtaining the index file from the projection server 10 and sends it to the projection server 10. Then, the simple server 222 obtains the image file stored in the HDD 221 based on a request for obtaining the image file sent from the projection server 10 and sends it to the projection server 10.

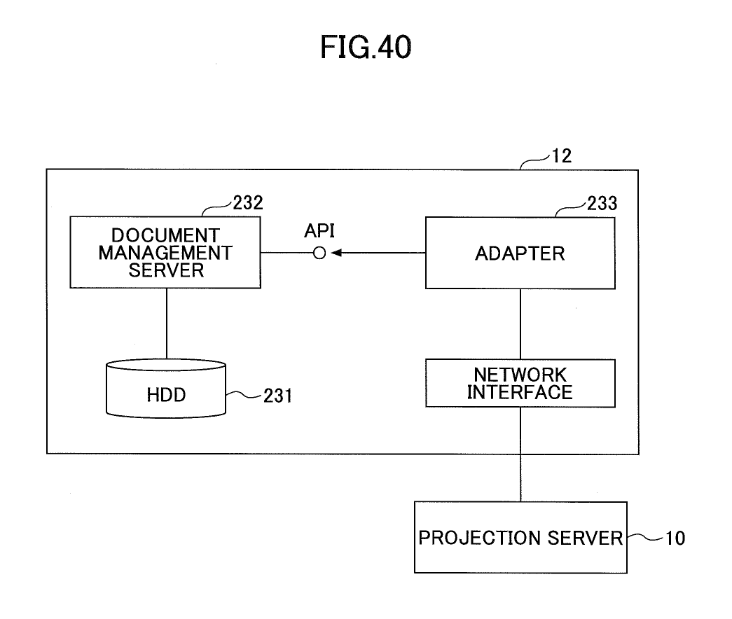

FIG. 40 is a block diagram showing an example of a structure of a storage server 12 which cooperates with the projection server 10. The storage server 12 includes a HDD 231, a document management server 232 and an adapter 233.

In the storage server 12 in FIG. 40, the document management server 232 manages image files stored in the HDD 231. The document management server 232 includes an API which receives a request for obtaining an image stored in the HDD 231.

The adapter 233 detects the image file stored in the HDD 231 based on the request for obtaining the index file from the projection server 10, using the API of the document management server 232. The adapter 233 generates an index file of the detected image file(s) and sends it to the projection server 10.

Further, the adapter 233 obtains the image file stored in the HDD 231 based on the request for obtaining the image file from the projection server 10 using the API of the document management server 232. The adapter 233 sends the obtained image file to the projection server 10.

According to the projection server 10 of the embodiment, a content file provided by one or more external services as well as a content file provided by an internal storage service are displayed as similar in appearance in a file list screen, and can be projected by the projector 15 with a similar operation regardless of the services from which the content files are provided. Thus, the convenience of the projector 15 is improved.

The content providing apparatus which provides content corresponds to the external Web service server 11, the storage server 12, the PC 13, the image input output device 14 or the like. The image display apparatus corresponds to the projector 15, for example. The server apparatus corresponds to the projection server 10, for example. The index data processing unit, the image data processing unit, and the content receiving unit correspond to the controller unit 34.

The individual constituents of the projection system 1 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications.

According to the embodiment, an image display technique capable of improving convenience of an image display apparatus is provided.

Although a preferred embodiment of the projection system has been specifically illustrated and described, it is to be understood that minor modifications may be made therein without departing from the spirit and scope of the invention as defined by the claims.

The present invention is not limited to the specifically disclosed embodiments, and variations and modifications may be made without departing from the scope of the present invention.

The present application is based on Japanese Priority Application No. 2012-049067 filed on Mar. 6, 2012, the entire contents of which are hereby incorporated by reference.

What is claimed is:

1. A server apparatus capable of connecting to a content providing apparatus which provides content and an image display apparatus via a network, comprising:
an index data processing unit which provides index data to the image display apparatus, based on content to be provided by the content providing apparatus, for having the image display apparatus display a list screen including information of the content; and
an image data processing unit which provides image data to the image display apparatus for having the image display apparatus display a content display screen using information of the content selected from the list screen by an operator.

2. The server apparatus according to claim 1,
wherein the index data processing unit provides the index data, based on a first content capable of being provided by the content providing apparatus and a second content previously stored in a storing unit of the server apparatus, for having the image display apparatus display the list screen including information of the first content and the second content.

3. The server apparatus according to claim 2,
wherein the list screen includes directories each indicating the content providing apparatus which provides the first content and the storing unit which stores the second content, the directories being provided for each of the content providing apparatuses when the server apparatus is connected to plural of the content providing apparatuses capable of providing contents, respectively.

4. The server apparatus according to claim 3,
wherein the list screen includes directories indicating the information of the first content and/or the second content when the first content and/or the second content are multi-page files, respectively.

5. The server apparatus according to claim 2, further comprising:
a format conversion unit which converts a format of the first content or the second content to a format capable of being displayed by the image display apparatus when it is necessary.

6. The server apparatus according to claim 2, wherein the image data processing unit includes a content receiving unit which receives the second content provided by the content providing apparatus, and stores it in the storing unit.

7. The server apparatus according to claim 2,
wherein the image data processing unit deletes the second content from the storing unit in accordance with the number of displayed times or the period previously set for the second content.

8. The server apparatus according to claim 2,
wherein the first content and the second content are provided with information indicating starts of validated periods, respectively, and the index data processing unit controls not to include the information of the first content and the second content for which the validated periods are not started in the index data.

9. The server apparatus according to claim 2,
wherein the index data processing unit and the image data processing unit obtain information for generating the index data and the image data, respectively, by cooperating with the content providing apparatus using authentication data for the content providing apparatus stored in the storing unit.

10. The server apparatus according to claim 9,
wherein the index data processing unit obtains an authentication token from the content providing apparatus and stores the authentication token in the storing unit, and the index data processing unit and the image data processing unit obtain the information of the content or the content from the content providing apparatus using the authentication token.

11. An image display system, comprising:
a server apparatus which provides content; and
an image display apparatus which displays the content and is connected to the server apparatus via a network,
wherein the server apparatus includes
an index data processing unit which provides index data to the image display apparatus, based on content to be provided by a content providing apparatus, for having the image display apparatus display a list screen including information of the content; and
an image data processing unit which provides image data to the image display apparatus for having the image display apparatus display a content display screen using information of the content selected from the list screen by an operator, and
the image display apparatus includes
a list screen display unit which displays the list screen including the information of the content based on the provided index data, and
a content display screen display unit which displays the content display screen based on the provided image data.

12. The image display system according to claim 11,
wherein the content providing apparatus is an image processing apparatus including an image input device capable of generating image data, and the content is the image data generated by the input device.

13. A non-transitory computer-readable recording medium having recorded thereon a program that causes a computer composed of a server apparatus capable of connecting to a content providing apparatus which provides content and an image display apparatus via a network, to execute a content providing method comprising:
providing index data to the image display apparatus, based on content to be provided by the content providing apparatus, for having the image display apparatus display a list screen including information of the content; and
providing image data to the image display apparatus for having the image display apparatus display a content display screen using information of the content selected from the list screen by an operator.
